(19) United States
(12) Patent Application Publication
(10) Pub. No.: US 2026/0020023 A1
(43) Pub. Date: Jan. 15, 2026

(54) CONTROL FRAME PROTECTION

(71) Applicant: Intel Corporation, Santa Clara, CA (US)

(72) Inventors: Po-Kai HUANG, San Ramon, CA (US); Danny ALEXANDER, Neve Efraim Monoson (IL); Danny BEN-ARI, Tsur Natan (IL); Daniel BRAVO, Portland, OR (US); Laurent CARIOU, Milizac (FR); Oded LIRON, Givat-Ada (IL)

(21) Appl. No.: 19/262,180

(22) Filed: Jul. 8, 2025

Related U.S. Application Data
(60) Provisional application No. 63/668,925, filed on Jul. 9, 2024.
(60) Provisional application No. 63/669,346, filed on Jul. 10, 2024.

(51) Int. Cl. H04W 72/20

(52) U.S. Cl. CPC H04W 72/20

(57) ABSTRACT

A device includes a memory; one or more processors, coupled to the memory, and configured to: determine if a trigger frame, a block acknowledgment request, BAR, frame, or a block acknowledgment, BA, frame received by the device are secured; initiate a message integrity code, MIC, calculation for a control integrity protocol (CIP); and determine the additional authentication data, AAD, for control frame protection.

### CROSS-REFERENCE TO RELATED APPLICATIONS

This application claims priority to U.S. provisional application 63/668,925, filed on Jul. 9, 2024, and to 63/669,346, filed on Jul. 10, 2024, the entire contents of each of which are incorporated herein by reference.

### BACKGROUND

Wireless devices are becoming common and are increasingly accessing wireless channels. The Institute of Electrical and Electronics Engineers (IEEE) has been developing one or more standards to enable the use of Radio Local Area Networking (RLAN), which may be used to implement a local area network wirelessly using radio signals. Third Generation Partnership Project (3GPP) cellular technologies have also started supporting RLAN with the introduction of Licensed Assisted Access (LAA) technology, in which an unlicensed band (e.g., a 5 GHz band) is used in combination with the licensed spectrum to improve service. LAA was introduced with LTE and was later extended to New Radio (NR-U) with 5G New Radio (NR). However, it is unclear how the additional authenticated data (AAD) will be constructed and how the MIC will be computed.

Moreover, it has been noted that there is a need for padding in case there are not enough time to deal with the additional MIC. There have been suggestions to have padding in the protected control frame itself and also the frame that solicits the control frame. However, it is not clear how padding can be constructed to meet the requirement of various cases.

### BRIEF DESCRIPTION OF THE DRAWINGS

In the drawings, like reference characters generally refer to the same parts throughout the different views. The drawings are not necessarily to scale, emphasis instead generally being placed upon illustrating the exemplary principles of the disclosure. In the following description, various exemplary embodiments of the disclosure are described with reference to the following drawings, in which:

FIG. 1 is a network diagram illustrating an example network environment for AAD Construction, in accordance with one or more example embodiments of the present disclosure.

FIG. 2-4 depict illustrative schematic diagrams for AAD Construction.

FIG. 5 depicts an existing BA, BAR, and Trigger frame format.

FIG. 6 depicts a BlockAckReq frame format.

FIG. 7 depicts a trigger frame format.

FIG. 8 depicts a frame control field format in non-DIG PPDUs when the type subfield is not equal to 1 or the subfield is not equal to 6.

FIG. 9 illustrates a flow diagram of illustrative process for an AAD Construction system.

FIG. 10 depicts a functional diagram of an exemplary communication station.

FIG. 11 depicts a block diagram of an example of a machine or system upon which any one or more of the techniques herein may be performed.

FIG. 12 is a block diagram of a radio architecture.

FIG. 13 illustrates WLAN FEM circuitry in accordance with some embodiments.

FIG. 14 illustrates an example radio IC circuitry for use in a radio architecture.

FIG. 15 is a block diagram of a radio architecture in accordance with some examples.

FIG. 16 is a network diagram illustrating an example network environment of padding.

FIG. 17 illustrates a flow diagram of illustrative process for a padding system.

FIG. 18 illustrates a functional diagram of an exemplary communication station that may be suitable for use as a user device, in accordance with one or more example embodiments of the present disclosure.

FIG. 19 illustrates a block diagram of an example of a machine or system.

FIG. 20 is a block diagram of a radio architecture.

FIG. 21 illustrates an example front-end module circuitry for use in the radio architecture of FIG. 15, in accordance with one or more example embodiments of the present disclosure.

FIG. 22 illustrates radio IC circuitry 2006a in accordance with some embodiments.

FIG. 23 illustrates a functional block diagram of baseband processing circuitry 2008a in accordance with some embodiments.

FIG. 24 depicts a frame structure for padding calculation.

### DESCRIPTION

The following detailed description refers to the accompanying drawings that show, by way of illustration, exemplary details and embodiments in which aspects of the present disclosure may be practiced.

The word “exemplary” is used herein to mean “serving as an example, instance, or illustration”. Any embodiment or design described herein as “exemplary” is not necessarily to be construed as preferred or advantageous over other embodiments or designs.

Throughout the drawings, it should be noted that like reference numbers are used to depict the same or similar elements, features, and structures, unless otherwise noted.

The phrase “at least one” and “one or more” may be understood to include a numerical quantity greater than or equal to one (e.g., one, two, three, four, [ . . . ], etc.). The phrase “at least one of” with regard to a group of elements may be used herein to mean at least one element from the group consisting of the elements. For example, the phrase “at least one of” with regard to a group of elements may be used herein to mean a selection of: one of the listed elements, a plurality of one of the listed elements, a plurality of individual listed elements, or a plurality of a multiple of individual listed elements.

The words “plural” and “multiple” in the description and in the claims expressly refer to a quantity greater than one. Accordingly, any phrases explicitly invoking the aforementioned words (e.g., “plural [elements]”, “multiple [elements]”) referring to a quantity of elements expressly refers to more than one of the said elements. For instance, the phrase “a plurality” may be understood to include a numerical quantity greater than or equal to two (e.g., two, three, four, five, [ . . . ], etc.).

The phrases “group (of)”, “set (of)”, “collection (of)”, “series (of)”, “sequence (of)”, “grouping (of)”, etc., in the description and in the claims, if any, refer to a quantity equal to or greater than one, i.e., one or more. The terms “proper subset”, “reduced subset”, and “lesser subset” refer to a subset of a set that is not equal to the set, illustratively, referring to a subset of a set that contains less elements than the set.

The term “data” as used herein may be understood to include information in any suitable analog or digital form, e.g., provided as a file, a portion of a file, a set of files, a signal or stream, a portion of a signal or stream, a set of signals or streams, and the like. Further, the term “data” may also be used to mean a reference to information, e.g., in form of a pointer. The term “data”, however, is not limited to the aforementioned examples and may take various forms and represent any information as understood in the art.

The terms “processor” or “controller” as, for example, used herein may be understood as any kind of technological entity that allows handling of data. The data may be handled according to one or more specific functions executed by the processor or controller. Further, a processor or controller as used herein may be understood as any kind of circuit, e.g., any kind of analog or digital circuit. A processor or a controller may thus be or include an analog circuit, digital circuit, mixed-signal circuit, logic circuit, processor, microprocessor, Central Processing Unit (CPU), Graphics Processing Unit (GPU), Digital Signal Processor (DSP), Field Programmable Gate Array (FPGA), integrated circuit, Application Specific Integrated Circuit (ASIC), etc., or any combination thereof. Any other kind of implementation of the respective functions, which will be described below in further detail, may also be understood as a processor, controller, or logic circuit. It is understood that any two (or more) of the processors, controllers, or logic circuits detailed herein may be realized as a single entity with equivalent functionality or the like, and conversely that any single processor, controller, or logic circuit detailed herein may be realized as two (or more) separate entities with equivalent functionality or the like.

As used herein, “memory” is understood as a computer-readable medium (e.g., a non-transitory computer-readable medium) in which data or information can be stored for retrieval. References to “memory” included herein may thus be understood as referring to volatile or non-volatile memory, including random access memory (RAM), read-only memory (ROM), flash memory, solid-state storage, magnetic tape, hard disk drive, optical drive, 3D XPoint™, among others, or any combination thereof. Registers, shift registers, processor registers, data buffers, among others, are also embraced herein by the term memory. The term “software” refers to any type of executable instruction, including firmware.

Unless explicitly specified, the term “transmit” encompasses both direct (point-to-point) and indirect transmission (via one or more intermediary points). Similarly, the term “receive” encompasses both direct and indirect reception. Furthermore, the terms “transmit,” “receive,” “communicate,” and other similar terms encompass both physical transmission (e.g., the transmission of radio signals) and logical transmission (e.g., the transmission of digital data over a logical software-level connection). For example, a processor or controller may transmit or receive data over a software-level connection with another processor or controller in the form of radio signals, where the physical transmission and reception is handled by radio-layer components such as RF transceivers and antennas, and the logical transmission and reception over the software-level connection is performed by the processors or controllers. The term “communicate” encompasses one or both of transmitting and receiving, i.e., unidirectional or bidirectional communication in one or both of the incoming and outgoing directions. The term “calculate” encompasses both ‘direct’ calculations via a mathematical expression/formula/relationship and ‘indirect’ calculations via lookup or hash tables and other array indexing or searching operations.

The following description and the drawings illustrate specific embodiments to enable those skilled in the art to practice them. Other embodiments may incorporate structural, logical, electrical, process, algorithm, and other changes. Portions and features of some embodiments may be included in, or substituted for, those of other embodiments.

Embodiments set forth in the claims encompass all available equivalents of those claims. Wireless local area network service, Wi-Fi 8, (e.g., based on IEEE 802.11bn, which may otherwise be known as ultra high reliability (UHR)) is the next generation of Wi-Fi and a successor to the IEEE 802.11be (Wi-Fi 7) standard. In line with all previous Wi-Fi standards, Wi-Fi 8 will aim to improve wireless performance in general along with introducing new and innovative features to further advance Wi-Fi technology.

Trigger frame, Block ACK Request (BAR) frame, and Block ACK (BA) frame protection have been discussed to resolve the security problems associated with the Trigger frames, the BAR frames, and the BA frames. Herein it is proposed to insert fields like a key ID, a message integrity code (MIC), and a packet number (PN) field somewhere in the Trigger frame, BAR frame, and BA frame before the frame check sequence (FCS) field so that MIC check can be done before continuing the following operation.

However, it is unclear how the AAD will be constructed and how the MIC will be computed.

Today, additional authenticated data (AAD) construction and MIC calculation for MIC-only mechanisms used by the broadcast/multicast integrity protocol (BIP) are defined as follows. It is to be noted that the MIC field is part of the computation, initialized as 0 for MIC calculation. However, the clarity is lacking on whether the same method will be employed for control frame protection. For instance, the control frame does not possess A3. It is noted that no previous solution describes how the AAD is constructed by control frame protection.

Example embodiments of the present disclosure relate to systems, methods, and devices for AAD construction for control frame protection. In one or more embodiments, an AAD Construction system may facilitate the addition of PN and MIC to the format, but it is unlikely that the PN and MIC fields will be added before the transmitter address (TA) fields.

Hence, for Trigger frame, BAR, and BA, a common portion of Frame Control, Duration, RA, and TA is identified, which functions like a kind of header. Thus, the AAD may be based on the common portion of Trigger frame, BAR, and BA.

For the MIC computation, it is proposed to base the MIC on the AAD and the fields after TA and before MIC fields. AAD construction and MIC computation have been defined. Discussion on the potential improvement to skip FCS check due to a successful MIC check is also provided.

The above descriptions are for purposes of illustration and are not meant to be limiting. Numerous other examples, configurations, processes, algorithms, etc., may exist, some of which are described in greater detail below. Example embodiments will now be described with reference to the accompanying figures.

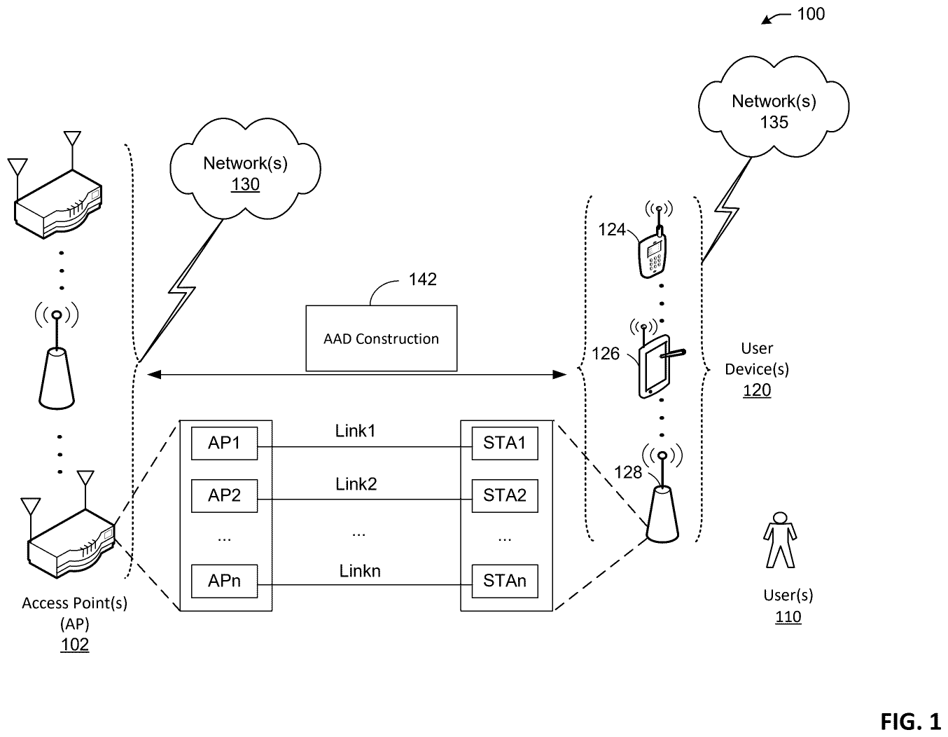

FIG. 1 is a network diagram illustrating an example network environment of AAD Construction, according to some example embodiments of the present disclosure. Wireless network 100 may include one or more user devices 120 and one or more access points(s) (AP) 102, which may communicate in accordance with IEEE 802.11 communication standards. The user device(s) 120 may be mobile devices that are non-stationary (e.g., not having fixed locations) or may be stationary devices.

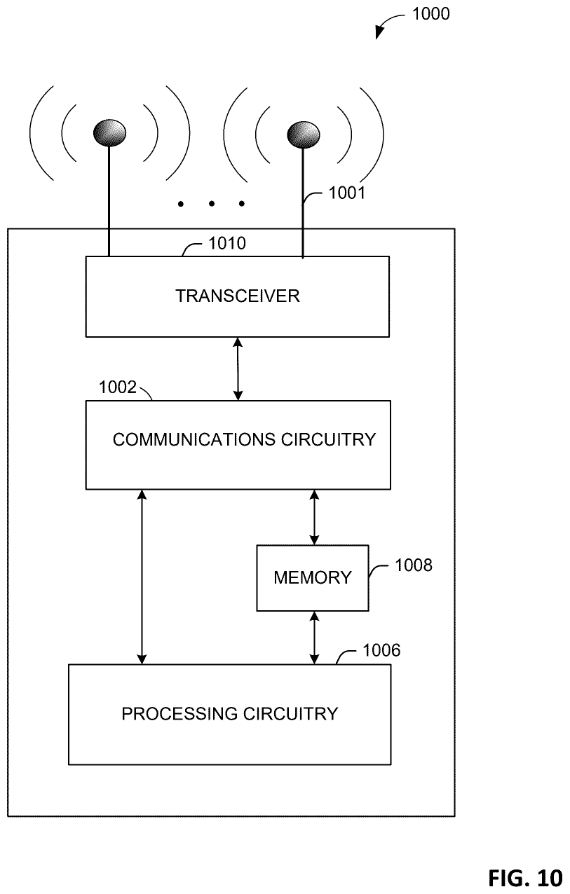

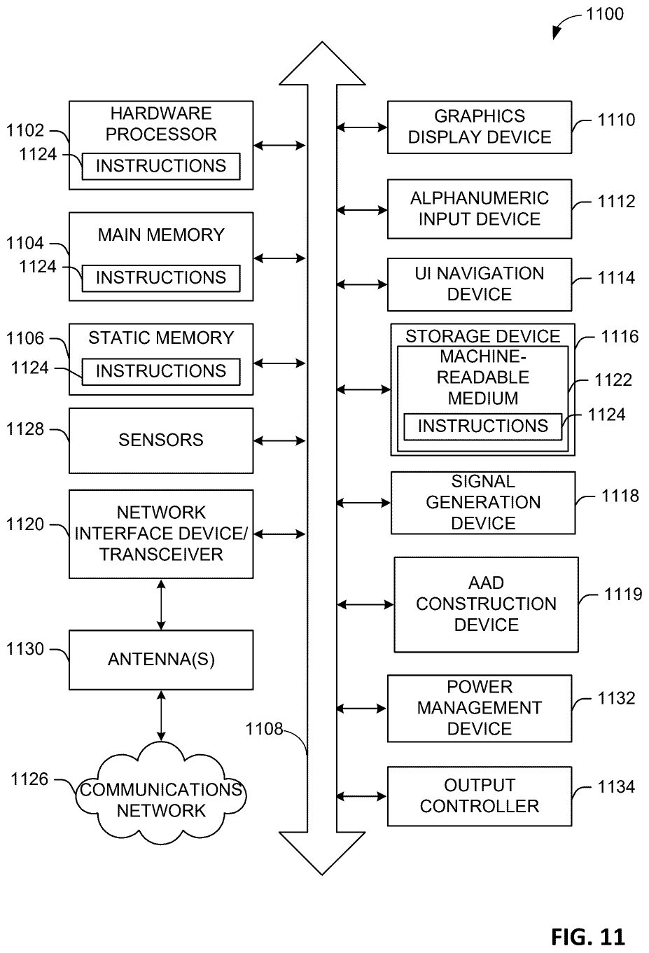

In some embodiments, the user devices 120 and the AP 102 may include one or more computer systems similar to that of the functional diagram of FIG. 10 and/or the example machine/system of FIG. 11.

One or more illustrative user device(s) 120 and/or AP(s) 102 may be operable by one or more user(s) 110. It should be noted that any addressable unit may be a station (STA). An STA may take on multiple distinct characteristics, each of which may shape its function. For example, a single addressable unit might simultaneously be a portable STA, a quality-of-service (QoS) STA, a dependent STA, and a hidden STA. The one or more illustrative user device(s) 120 and the AP(s) 102 may be STAs. The one or more illustrative user device(s) 120 and/or AP(s) 102 may operate as a personal basic service set (PBSS) control point/access point (PCP/AP). The user device(s) 120 (e.g., 124, 126, or 128) and/or AP(s) 102 may include any suitable processor-driven device including, but not limited to, a mobile device or a non-mobile, e.g., a static device. For example, user device(s) 120 and/or AP(s) 102 may include, a user equipment (UE), a station (STA), an access point (AP), a software enabled AP (SoftAP), a personal computer (PC), a wearable wireless device (e.g., bracelet, watch, glasses, ring, etc.), a desktop computer, a mobile computer, a laptop computer, an Ultrabook™ computer, a notebook computer, a tablet computer, a server computer, a handheld computer, a handheld device, an internet of things (IoT) device, a sensor device, a PDA device, a handheld PDA device, an on-board device, an off-board device, a hybrid device (e.g., combining cellular phone functionalities with PDA device functionalities), a consumer device, a vehicular device, a non-vehicular device, a mobile or portable device, a non-mobile or non-portable device, a mobile phone, a cellular telephone, a PCS device, a PDA device which incorporates a wireless communication device, a mobile or portable GPS device, a DVB device, a relatively small computing device, a non-desktop computer, a “carry small live large” (CSLL) device, an ultra mobile device (UMD), an ultra mobile PC (UMPC), a mobile internet device (MID), an “origami” device or computing device, a device that supports dynamically composable computing (DCC), a context-aware device, a video device, an audio device, an A/V device, a set-top-box (STB), a blu-ray disc (BD) player, a BD recorder, a digital video disc (DVD) player, a high definition (HD) DVD player, a DVD recorder, a HD DVD recorder, a personal video recorder (PVR), a broadcast HD receiver, a video source, an audio source, a video sink, an audio sink, a stereo tuner, a broadcast radio receiver, a flat panel display, a personal media player (PMP), a digital video camera (DVC), a digital audio player, a speaker, an audio receiver, an audio amplifier, a gaming device, a data source, a data sink, a digital still camera (DSC), a media player, a smartphone, a television, a music player, or the like. Other devices, including smart devices such as lamps, climate control, car components, household components, appliances, etc. may also be included in this list.

As used herein, the term “Internet of Things (IoT) device” is used to refer to any object (e.g., an appliance, a sensor, etc.) that has an addressable interface (e.g., an Internet protocol (IP) address, a Bluetooth identifier (ID), a near-field communication (NFC) ID, etc.) and can transmit information to one or more other devices over a wired or wireless connection. An IoT device may have a passive communication interface, such as a quick response (QR) code, a radio-frequency identification (RFID) tag, an NFC tag, or the like, or an active communication interface, such as a modem, a transceiver, a transmitter-receiver, or the like. An IoT device can have a particular set of attributes (e.g., a device state or status, such as whether the IoT device is on or off, open or closed, idle or active, available for task execution or busy, and so on, a cooling or heating function, an environmental monitoring or recording function, a light-emitting function, a sound-emitting function, etc.) that can be embedded in and/or controlled/monitored by a central processing unit (CPU), microprocessor, ASIC, or the like, and configured for connection to an IoT network such as a local ad-hoc network or the Internet. For example, IoT devices may include, but are not limited to, refrigerators, toasters, ovens, microwaves, freezers, dishwashers, dishes, hand tools, clothes washers, clothes dryers, furnaces, air conditioners, thermostats, televisions, light fixtures, vacuum cleaners, sprinklers, electricity meters, gas meters, etc., so long as the devices are equipped with an addressable communications interface for communicating with the IoT network. IoT devices may also include cell phones, desktop computers, laptop computers, tablet computers, personal digital assistants (PDAs), etc. Accordingly, the IoT network may be comprised of a combination of “legacy” Internet-accessible devices (e.g., laptop or desktop computers, cell phones, etc.) in addition to devices that do not typically have Internet-connectivity (e.g., dishwashers, etc.).

The user device(s) 120 and/or AP(s) 102 may also include mesh stations in, for example, a mesh network, in accordance with one or more IEEE 802.11 standards and/or 3GPP standards.

Any of the user device(s) 120 (e.g., user devices 124, 126, 128), and AP(s) 102 may be configured to communicate with each other via one or more communications networks 130 and/or 135 wirelessly or wired. The user device(s) 120 may also communicate peer-to-peer or directly with each other with or without the AP(s) 102. Any of the communications networks 130 and/or 135 may include, but not limited to, any one of a combination of different types of suitable communications networks such as, for example, broadcasting networks, cable networks, public networks (e.g., the Internet), private networks, wireless networks, cellular networks, or any other suitable private and/or public networks. Further, any of the communications networks 130 and/or 135 may have any suitable communication range associated therewith and may include, for example, global networks (e.g., the Internet), metropolitan area networks (MANs), wide area networks (WANs), local area networks (LANs), or personal area networks (PANs). In addition, any of the communications networks 130 and/or 135 may include any type of medium over which network traffic may be carried including, but not limited to, coaxial cable, twisted-pair wire, optical fiber, a hybrid fiber coaxial (HFC) medium, microwave terrestrial transceivers, radio frequency communication mediums, white space communication mediums, ultra-high frequency communication mediums, satellite communication mediums, or any combination thereof.

Any of the user device(s) 120 (e.g., user devices 124, 126, 128) and AP(s) 102 may include one or more communications antennas. The one or more communications antennas may be any suitable type of antennas corresponding to the communications protocols used by the user device(s) 120 (e.g., user devices 124, 126 and 128), and AP(s) 102. Some non-limiting examples of suitable communications antennas include Wi-Fi antennas, Institute of Electrical and Electronics Engineers (IEEE) 802.11 family of standards compatible antennas, directional antennas, non-directional antennas, dipole antennas, folded dipole antennas, patch antennas, multiple-input multiple-output (MIMO) antennas, omnidirectional antennas, quasi-omnidirectional antennas, or the like. The one or more communications antennas may be communicatively coupled to a radio component to transmit and/or receive signals, such as communications signals to and/or from the user devices 120 and/or AP(s) 102.

Any of the user device(s) 120 (e.g., user devices 124, 126, 128), and AP(s) 102 may be configured to perform directional transmission and/or directional reception in conjunction with wirelessly communicating in a wireless network. Any of the user device(s) 120 (e.g., user devices 124, 126, 128), and AP(s) 102 may be configured to perform such directional transmission and/or reception using a set of multiple antenna arrays (e.g., DMG antenna arrays or the like). Each of the multiple antenna arrays may be used for transmission and/or reception in a particular respective direction or range of directions. Any of the user device(s) 120 (e.g., user devices 124, 126, 128), and AP(s) 102 may be configured to perform any given directional transmission towards one or more defined transmit sectors. Any of the user device(s) 120 (e.g., user devices 124, 126, 128), and AP(s) 102 may be configured to perform any given directional reception from one or more defined receive sectors.

MIMO beamforming in a wireless network may be accomplished using RF beamforming and/or digital beamforming. In some embodiments, in performing a given MIMO transmission, user devices 120 and/or AP(s) 102 may be configured to use all or a subset of their one or more communications antennas to perform MIMO beamforming.

Any of the user devices 120 (e.g., user devices 124, 126, 128), and AP(s) 102 may include any suitable radio and/or transceiver for transmitting and/or receiving radio frequency (RF) signals in the bandwidth and/or channels corresponding to the communications protocols utilized by any of the user device(s) 120 and AP(s) 102 to communicate with each other. The radio components may include hardware and/or software to modulate and/or demodulate communications signals according to pre-established transmission protocols. The radio components may further have hardware and/or software instructions to communicate via one or more Wi-Fi and/or Wi-Fi direct protocols, as standardized by the Institute of Electrical and Electronics Engineers (IEEE) 802.11 standards. In certain example embodiments, the radio component, in cooperation with the communications antennas, may be configured to communicate via 2.4 GHz channels (e.g. 802.11b, 802.11g, 802.11n, 802.11ax), 5 GHz channels (e.g. 802.11n, 802.11ac, 802.11ax, 802.11be, 802.11bn, etc.), 6 GHz channels (e.g., 802.11ax, 802.11be, 802.11bn, etc.), 60 GHz channels (e.g. 802.11ad, 802.11ay), or 800 MHz channels (e.g. 802.11ah). The communications antennas may operate at 28 GHz and 40 GHz. It should be understood that this list of communication channels in accordance with certain 802.11 standards is only a partial list and that other 802.11 standards may be used (e.g., Next Generation Wi-Fi, or other standards). In some embodiments, non-Wi-Fi protocols may be used for communications between devices, such as Bluetooth, dedicated short-range communication (DSRC), Ultra-High Frequency (UHF) (e.g. IEEE 802.11af, IEEE 802.22), white band frequency (e.g., white spaces), or other packetized radio communications. The radio component may include any known receiver and baseband suitable for communicating via the communications protocols. The radio component may further include a low noise amplifier (LNA), additional signal amplifiers, an analog-to-digital (A/D) converter, one or more buffers, and digital baseband.

In one embodiment, and with reference to FIG. 1, a user device 120 may be in communication with one or more APs 102. For example, one or more APs 102 may implement an AAD Construction 142 with one or more user devices 120. The one or more APs 102 may be multi-link devices (MLDs) and the one or more user device 120 may be non-AP MLDs. Each of the one or more APs 102 may comprise a plurality of individual APs (e.g., AP1, AP2, . . . , APn, where n is an integer) and each of the one or more user devices 120 may comprise a plurality of individual STAs (e.g., STA1, STA2, . . . , STAn). The AP MLDs and the non-AP MLDs may set up one or more links (e.g., Link1, Link2, . . . , Linkn) between each of the individual APs and STAs. It is understood that the above descriptions are for the purposes of illustration and are not meant to be limiting.

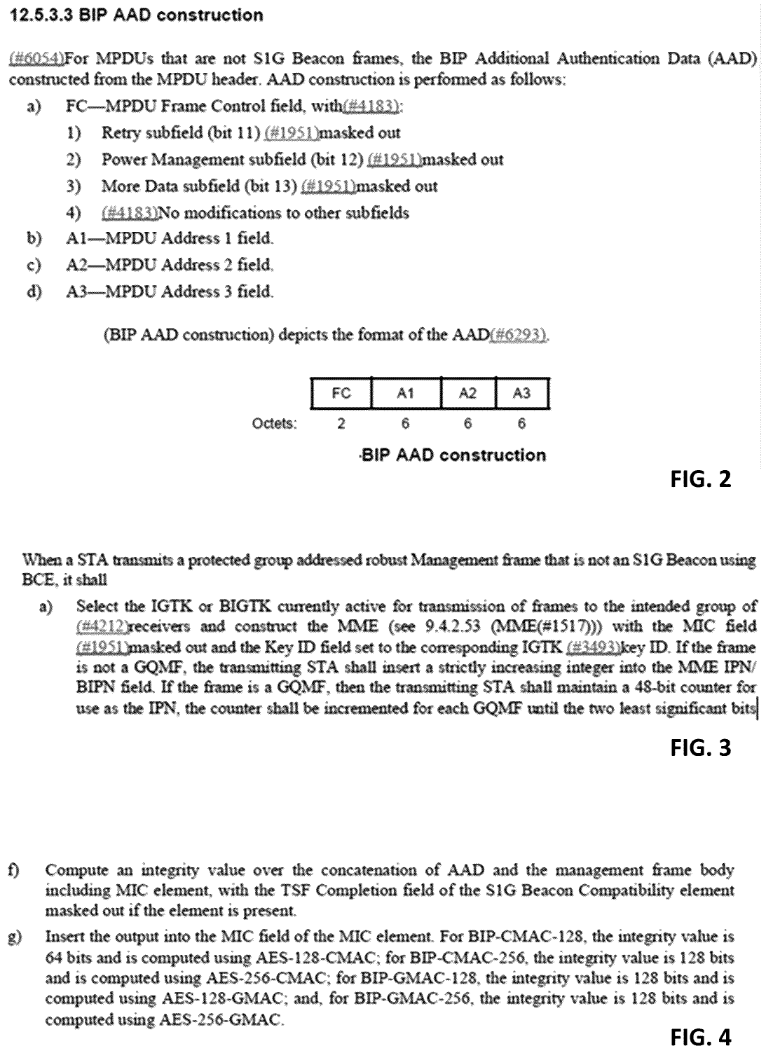

FIGS. 2-4 depict illustrative schematic diagrams for AAD Construction, in accordance with one or more example embodiments of the present disclosure. In FIG. 2, the BIP additional authentication data (AAD) is disclosed as being constructed from the MPDU header for MPDUs that are not DIG beacon frames. In FIG. 3, an STA transmitting a protected group addressed robust management frame that is not an SIG beacon using BCE is disclosed as selecting the IGTK or BIGTK currently active for transmissions of frames to the intended group of receivers and constructing the MME with the MIC field marked out and the Key ID field set to the corresponding IGTK key ID.

FIG. 4 discloses the computation of an integrity value of the concatenation of AAD and the management frame body including MIC elements, wherein the TSF completion field of the SIG beacon comparability element is masked out of the element is present.

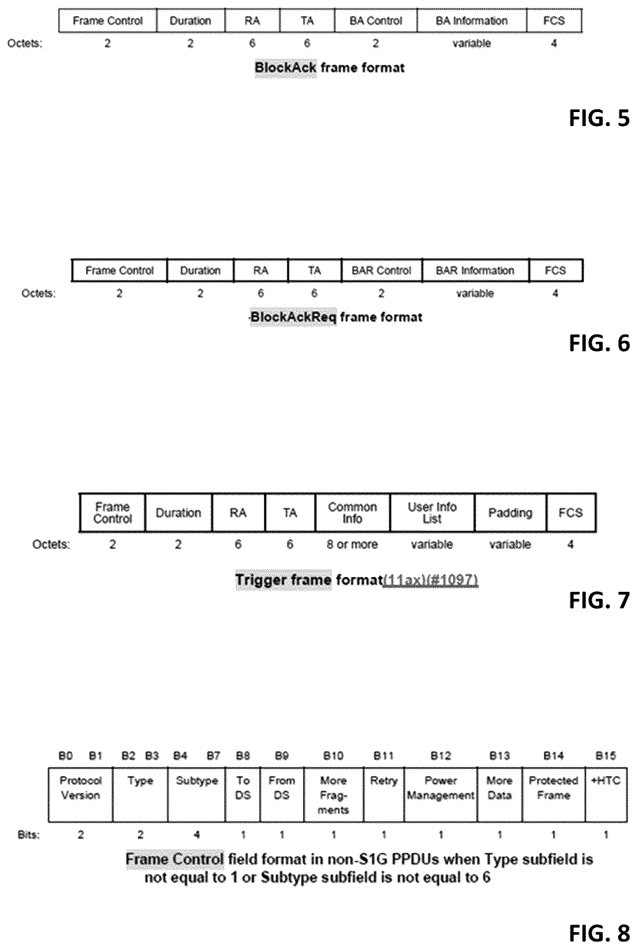

FIG. 5 depicts an existing BA, BAR, and Trigger frame format.

FIG. 6 depicts a BlockAckReq frame format.

FIG. 7 depicts a trigger frame format.

FIG. 8 depicts a frame control field format in non-DIG PPDUs when the type subfield is not equal to 1 or the subfield is not equal to 6.

The design of the AAD starts as follows:
The AAD of the control frame protection for Trigger, BAR and BA may include
   Frame Control
   Duration
   RA
   TA
No masking out of fields of Frame control in the AAD
   The frame control field for Trigger, BAR, BA is shown in the figures.
   Note that there is no retry, PM, and more data usage for Control frame, so not masking out any fields makes sense for the design.

There are two options for the duration field:

Option 1: not masked out. This ensures that the duration field is protected and that essentially all fields before the MIC can be protected.

Option 2: the duration field is masked out. This may allow the MIC to be computed beforehand and may allow the duration to be inserted to the frame before the transmission.

Option 3: the duration field is not included at all in the AAD construction. Only the RA and TA fields are included, and no fields are masked out.

The MIC computation may be continued as follows:

Compute an integrity value over the concatenation of the AAD and fields after the TA field and before the MIC field, i.e., the MIC field is not included. This will save the time corresponding to the critical computation of MIC for control frame protection.

The design of the FCS check is continued as follows:

If the duration field is included in the AAD for MIC computation, then the following FCS check or intermediate FCS check is not required by the receiving STA of the protected control frame.

Note that based on the current 802.11 specification (“spec”), the FCS check is required by the receiving STA. This is feasible because all the fields are essentially protected by the MIC, so the FCS check ensuring correctness of the frame is not required.

AN STA shall validate every received frame using the frame check sequence (FCS) and shall interpret certain fields from the MAC headers of all frames. The design for easing the preparation of transmitting control frames with MIC is continued as follows:

If the duration field is not included in the AAD for MIC computation, it is likely due to the fact that computing the MIC right before transmission is not possible. In that case, the PN of the frame also needs to be selected beforehand. However, if there are other control frames like the BA that are solicited before the transmission of the queued frame, then the preselected PN will be smaller than the reply counter, which causes the frame to be dropped.

It is then proposed that two replay counters be utilized for the replay check of protected control frames:
One replay counter may be used for the control frame and may be sent without solicitation.
One replay counter may be used for the control frame and may only be solicited to be sent rather than sent without solicitation.
The design then allows the PN for the control frame that was maybe sent without solicitation to be preselected without issues and enables MIC precomputation when the control frame is queued. It is understood that the above descriptions are for the purposes of illustration and are not meant to be limiting.

Another way to understand this would be as a device or method to protect the trigger frame, BAR frame and BA frame to resolve the security problem described above. That is, the control frames are not protected, despite their having important features. For example, the trigger frame triggers stations to send data, even for long durations, which could be exploited to cause a recipient to unnecessarily and undesirably send data for long durations. Moreover, the trigger frame is used for power saving and could waste power if it was used to cause the device to wake up repeatedly. The BAR frame relates to the data cue and can be used to move the data cue location. The BA is related to the transmitter cue and could be used to cause data to drop randomly.

In the device and method disclosed herein, an MIC, which is computed from a key for tag verification, is used to increase protection. That is, the AAD is calculated, followed by the MIC. Although certain other frame types may include a kind of protection using related concepts, this protection does not exist for control frames, whose format is completely different, and thus requires a new design.

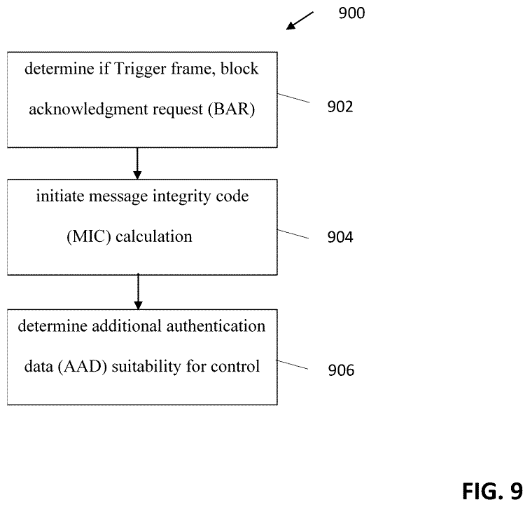

FIG. 9 illustrates a flow diagram of illustrative process 900 for an AAD Construction system, in accordance with one or more example embodiments of the present disclosure.

At block 902, a device (e.g., the user device(s) 120 and/or the AP 102 of FIG. 1 and/or the AAD Construction device 1119 of FIG. 11) may determine if the trigger frame, block acknowledgment request (BAR) frame, or block acknowledgment (BA) frame received are secured.

At block 904, the device may initiate a message integrity code (MIC) calculation for the broadcast/multicast integrity protocol (BIP).

At block 906, the device may determine additional authentication data (AAD) suitability for control frame protection.

It is understood that the above descriptions are for the purposes of illustration and are not meant to be limiting.

FIG. 10 shows a functional diagram of an exemplary communication station 1000, in accordance with one or more example embodiments of the present disclosure. In one embodiment, FIG. 10 illustrates a functional block diagram of a communication station that may be suitable for use as an AP 102 (FIG. 1) or a user device 120 (FIG. 1) in accordance with some embodiments. The communication station 1000 may also be suitable for use as a handheld device, a mobile device, a cellular telephone, a smartphone, a tablet, a netbook, a wireless terminal, a laptop computer, a wearable computer device, a femtocell, a high data rate (HDR) subscriber station, an access point, an access terminal, or other personal communication system (PCS) device.

The communication station 1000 may include communications circuitry 1002 and a transceiver 1010 for transmitting and receiving signals to and from other communication stations using one or more antennas 1001. The communications circuitry 1002 may include circuitry that can operate the physical layer (PHY) communications and/or medium access control (MAC) communications for controlling access to the wireless medium, and/or any other communications layers for transmitting and receiving signals. The communication station 1000 may also include processing circuitry 1006 and memory 1008 arranged to perform the operations described herein. In some embodiments, the communications circuitry 1002 and the processing circuitry 1006 may be configured to perform operations detailed in the above figures, diagrams, and flows.

In accordance with some embodiments, the communications circuitry 1002 may be arranged to contend for a wireless medium and configure frames or packets for communicating over the wireless medium. The communications circuitry 1002 may be arranged to transmit and receive signals. The communications circuitry 1002 may also include circuitry for modulation/demodulation, upconversion/downconversion, filtering, amplification, etc. In some embodiments, the processing circuitry 1006 of the communication station 1000 may include one or more processors. In other embodiments, two or more antennas 1001 may be coupled to the communications circuitry 1002 arranged for sending and receiving signals. The memory 1008 may store information for configuring the processing circuitry 1006 to perform operations for configuring and transmitting message frames and performing the various operations described herein. The memory 1008 may include any type of memory, including non-transitory memory, for storing information in a form readable by a machine (e.g., a computer). For example, the memory 1008 may include a computer-readable storage device, read-only memory (ROM), random-access memory (RAM), magnetic disk storage media, optical storage media, flash-memory devices and other storage devices and media.

In some embodiments, the communication station 1000 may be part of a portable wireless communication device, such as a personal digital assistant (PDA), a laptop or portable computer with wireless communication capability, a web tablet, a wireless telephone, a smartphone, a wireless headset, a pager, an instant messaging device, a digital camera, an access point, a television, a medical device (e.g., a heart rate monitor, a blood pressure monitor, etc.), a wearable computer device, or another device that may receive and/or transmit information wirelessly.

In some embodiments, the communication station 1000 may include one or more antennas 1001. The antennas 1001 may include one or more directional or omnidirectional antennas, including, for example, dipole antennas, monopole antennas, patch antennas, loop antennas, microstrip antennas, or other types of antennas suitable for transmission of RF signals. In some embodiments, instead of two or more antennas, a single antenna with multiple apertures may be used. In these embodiments, each aperture may be considered a separate antenna. In some multiple-input multiple-output (MIMO) embodiments, the antennas may be effectively separated for spatial diversity and the different channel characteristics that may result between each of the antennas and the antennas of a transmitting station.

In some embodiments, the communication station 1000 may include one or more of a keyboard, a display, a non-volatile memory port, multiple antennas, a graphics processor, an application processor, speakers, and other mobile device elements. The display may be an LCD screen including a touch screen.

Although the communication station 1000 is illustrated as having several separate functional elements, two or more of the functional elements may be combined and may be implemented by combinations of software-configured elements, such as processing elements including digital signal processors (DSPs), and/or other hardware elements. For example, some elements may include one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements of the communication station 1000 may refer to one or more processes operating on one or more processing elements.

Certain embodiments may be implemented in one or a combination of hardware, firmware, and software. Other embodiments may also be implemented as instructions stored on a computer-readable storage device, which may be read and executed by at least one processor to perform the operations described herein. A computer-readable storage device may include any non-transitory memory mechanism for storing information in a form readable by a machine (e.g., a computer). For example, a computer-readable storage device may include read-only memory (ROM), random-access memory (RAM), magnetic disk storage media, optical storage media, flash-memory devices, and other storage devices and media. In some embodiments, the communication station 1000 may include one or more processors and may be configured with instructions stored on a computer-readable storage device.

FIG. 11 illustrates a block diagram of an example of a machine 1100 or system upon which any one or more of the techniques (e.g., methodologies) discussed herein may be performed. In other embodiments, the machine 1100 may operate as a standalone device or may be connected (e.g., networked) to other machines. In a networked deployment, the machine 1100 may operate in the capacity of a server machine, a client machine, or both in server-client network environments. In an example, the machine 1100 may act as a peer machine in peer-to-peer (P2P) (or other distributed) network environments. The machine 1100 may be a personal computer (PC), a tablet PC, a set-top box (STB), a personal digital assistant (PDA), a mobile telephone, a wearable computer device, a web appliance, a network router, a switch or bridge, or any machine capable of executing instructions (sequential or otherwise) that specify actions to be taken by that machine, such as a base station. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), or other computer cluster configurations.

Examples, as described herein, may include or may operate on logic or a number of components, modules, or mechanisms. Modules are tangible entities (e.g., hardware) capable of performing specified operations when operating. A module includes hardware. In an example, the hardware may be specifically configured to carry out a specific operation (e.g., hardwired). In another example, the hardware may include configurable execution units (e.g., transistors, circuits, etc.) and a computer readable medium containing instructions where the instructions configure the execution units to carry out a specific operation when in operation. The configuring may occur under the direction of the executions units or a loading mechanism. Accordingly, the execution units are communicatively coupled to the computer-readable medium when the device is operating. In this example, the execution units may be a member of more than one module. For example, under operation, the execution units may be configured by a first set of instructions to implement a first module at one point in time and reconfigured by a second set of instructions to implement a second module at a second point in time.

The machine (e.g., computer system) 1100 may include a hardware processor 1102 (e.g., a central processing unit (CPU), a graphics processing unit (GPU), a hardware processor core, or any combination thereof), a main memory 1104 and a static memory 1106, some or all of which may communicate with each other via an interlink (e.g., bus) 1108. The machine 1100 may further include a power management device 1132, a graphics display device 1110, an alphanumeric input device 1112 (e.g., a keyboard), and a user interface (UI) navigation device 1114 (e.g., a mouse). In an example, the graphics display device 1110, alphanumeric input device 1112, and UI navigation device 1114 may be a touch screen display. The machine 1100 may additionally include a storage device (i.e., drive unit) 1116, a signal generation device 1118 (e.g., a speaker), a AAD Construction device 1119, a network interface device/transceiver 1120 coupled to antenna(s) 1130, and one or more sensors 1128, such as a global positioning system (GPS) sensor, a compass, an accelerometer, or other sensor. The machine 1100 may include an output controller 1134, such as a serial (e.g., universal serial bus (USB), parallel, or other wired or wireless (e.g., infrared (IR), near field communication (NFC), etc.) connection to communicate with or control one or more peripheral devices (e.g., a printer, a card reader, etc.)). The operations in accordance with one or more example embodiments of the present disclosure may be carried out by a baseband processor. The baseband processor may be configured to generate corresponding baseband signals. The baseband processor may further include physical layer (PHY) and medium access control layer (MAC) circuitry, and may further interface with the hardware processor 1102 for generation and processing of the baseband signals and for controlling operations of the main memory 1104, the storage device 1116, and/or the AAD Construction device 1119. The baseband processor may be provided on a single radio card, a single chip, or an integrated circuit (IC).

The storage device 1116 may include a machine readable medium 1122 on which is stored one or more sets of data structures or instructions 1124 (e.g., software) embodying or utilized by any one or more of the techniques or functions described herein. The instructions 1124 may also reside, completely or at least partially, within the main memory 1104, within the static memory 1106, or within the hardware processor 1102 during execution thereof by the machine 1100. In an example, one or any combination of the hardware processor 1102, the main memory 1104, the static memory 1106, or the storage device 1116 may constitute machine-readable media.

The AAD Construction device 1119 may carry out or perform any of the operations and processes (e.g., process 900) described and shown above.

It is understood that the above are only a subset of what the AAD Construction device 1119 may be configured to perform and that other functions included throughout this disclosure may also be performed by the AAD Construction device 1119.

While the machine-readable medium 1122 is illustrated as a single medium, the term “machine-readable medium” may include a single medium or multiple media (e.g., a centralized or distributed database, and/or associated caches and servers) configured to store the one or more instructions 1124.

Various embodiments may be implemented fully or partially in software and/or firmware. This software and/or firmware may take the form of instructions contained in or on a non-transitory computer-readable storage medium. Those instructions may then be read and executed by one or more processors to enable performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read only memory (ROM); random access memory (RAM); magnetic disk storage media; optical storage media; a flash memory, etc.

The term “machine-readable medium” may include any medium that is capable of storing, encoding, or carrying instructions for execution by the machine 1100 and that cause the machine 1100 to perform any one or more of the techniques of the present disclosure, or that is capable of storing, encoding, or carrying data structures used by or associated with such instructions. Non-limiting machine-readable medium examples may include solid-state memories and optical and magnetic media. In an example, a massed machine-readable medium includes a machine-readable medium with a plurality of particles having resting mass. Specific examples of massed machine-readable media may include non-volatile memory, such as semiconductor memory devices (e.g., electrically programmable read-only memory (EPROM), or electrically erasable programmable read-only memory (EEPROM)) and flash memory devices; magnetic disks, such as internal hard disks and removable disks; magneto-optical disks; and CD-ROM and DVD-ROM disks.

The instructions 1124 may further be transmitted or received over a communications network 1126 using a transmission medium via the network interface device/transceiver 1120 utilizing any one of a number of transfer protocols (e.g., frame relay, internet protocol (IP), transmission control protocol (TCP), user datagram protocol (UDP), hypertext transfer protocol (HTTP), etc.). Example communications networks may include a local area network (LAN), a wide area network (WAN), a packet data network (e.g., the Internet), mobile telephone networks (e.g., cellular networks), plain old telephone (POTS) networks, wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, and peer-to-peer (P2P) networks, among others. In an example, the network interface device/transceiver 1120 may include one or more physical jacks (e.g., Ethernet, coaxial, or phone jacks) or one or more antennas to connect to the communications network 1126. In an example, the network interface device/transceiver 1120 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding, or carrying instructions for execution by the machine 1100 and includes digital or analog communications signals or other intangible media to facilitate communication of such software.

The operations and processes described and shown above may be carried out or performed in any suitable order as desired in various implementations. Additionally, in certain implementations, at least a portion of the operations may be carried out in parallel. Furthermore, in certain implementations, less than or more than the operations described may be performed.

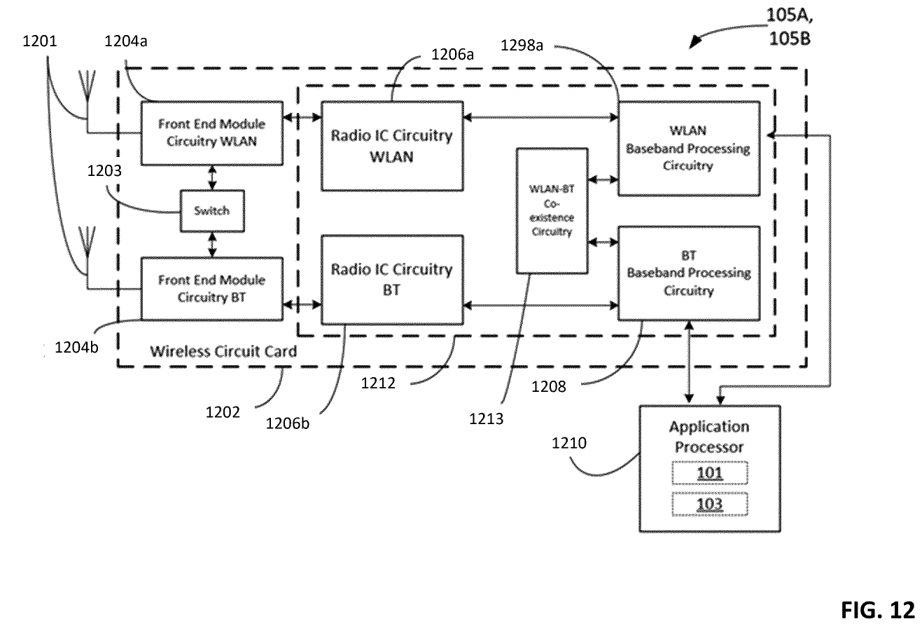

FIG. 12 is a block diagram of a radio architecture 105A, 105B in accordance with some embodiments that may be implemented in any one of the example APs 102 and/or the example STAs 120 of FIG. 1. Radio architecture 105A and 105B may include radio front-end module (FEM) circuitry 1204a-b, radio IC circuitry 1206a-b and baseband processing circuitry 1208a-b. Radio architecture 105A, 105B as shown includes both Wireless Local Area Network (WLAN) functionality and Bluetooth (BT) functionality, although embodiments are not so limited. In this disclosure, “WLAN” and “Wi-Fi” are used interchangeably.

FEM circuitry 1204a-b may include a WLAN or Wi-Fi FEM circuitry 1204a and a Bluetooth (BT) FEM circuitry 1204b. The WLAN FEM circuitry 1204a may include a receive signal path comprising circuitry configured to operate on WLAN RF signals received from one or more antennas 1201, to amplify the received signals and to provide the amplified versions of the received signals to the WLAN radio IC circuitry 1206a for further processing. The BT FEM circuitry 1204b may include a receive signal path which may include circuitry configured to operate on BT RF signals received from one or more antennas 1201, to amplify the received signals and to provide the amplified versions of the received signals to the BT radio IC circuitry 1206b for further processing. FEM circuitry 1204a may also include a transmit signal path which may include circuitry configured to amplify WLAN signals provided by the radio IC circuitry 1206a for wireless transmission by one or more of the antennas 1201. In addition, FEM circuitry 1204b may also include a transmit signal path which may include circuitry configured to amplify BT signals provided by the radio IC circuitry 1206b for wireless transmission by the one or more antennas. In the embodiment of FIG. 12, although FEM 1204a and FEM 1204b are shown as being distinct from one another, embodiments are not so limited, and such embodiments may include within their scope the use of an FEM (not shown) that includes a transmit path and/or a receive path for both WLAN and BT signals, or the use of one or more FEM circuitries where at least some of the FEM circuitries share transmit and/or receive signal paths for both WLAN and BT signals.

Radio IC circuitry 1206a-b as shown may include WLAN radio IC circuitry 1206a and BT radio IC circuitry 1206b. The WLAN radio IC circuitry 1206a may include a receive signal path which may include circuitry to down-convert WLAN RF signals received from the FEM circuitry 1204a and provide baseband signals to WLAN baseband processing circuitry 1208a. BT radio IC circuitry 1206b may in turn include a receive signal path which may include circuitry to down-convert BT RF signals received from the FEM circuitry 1204b and provide baseband signals to BT baseband processing circuitry 1208b. WLAN radio IC circuitry 1206a may also include a transmit signal path which may include circuitry to up-convert WLAN baseband signals provided by the WLAN baseband processing circuitry 1208a and provide WLAN RF output signals to the FEM circuitry 1204a for subsequent wireless transmission by the one or more antennas 1201. BT radio IC circuitry 1206b may also include a transmit signal path which may include circuitry to up-convert BT baseband signals provided by the BT baseband processing circuitry 1208b and provide BT RF output signals to the FEM circuitry 1204b for subsequent wireless transmission by the one or more antennas 1201. In the embodiment of FIG. 12, although radio IC circuitries 1206a and 1206b are shown as being distinct from one another, embodiments are not so limited, and include within their scope the use of a radio IC circuitry (not shown) that includes a transmit signal path and/or a receive signal path for both WLAN and BT signals, or the use of one or more radio IC circuitries where at least some of the radio IC circuitries share transmit and/or receive signal paths for both WLAN and BT signals.

Baseband processing circuitry 1208a-b may include a WLAN baseband processing circuitry 1208a and a BT baseband processing circuitry 1208b. The WLAN baseband processing circuitry 1208a may include a memory, such as, for example, a set of RAM arrays in a Fast Fourier Transform or Inverse Fast Fourier Transform block (not shown) of the WLAN baseband processing circuitry 1208a. Each of the WLAN baseband circuitry 1208a and the BT baseband circuitry 1208b may further include one or more processors and control logic to process the signals received from the corresponding WLAN or BT receive signal path of the radio IC circuitry 1206a-b, and to also generate corresponding WLAN or BT baseband signals for the transmit signal path of the radio IC circuitry 1206a-b. Each of the baseband processing circuitries 1208a and 1208b may further include physical layer (PHY) and medium access control layer (MAC) circuitry, and may further interface with a device for generation and processing of the baseband signals and for controlling operations of the radio IC circuitry 1206a-b.

Referring still to FIG. 12, according to the shown embodiment, WLAN-BT coexistence circuitry 1213 may include logic providing an interface between the WLAN baseband circuitry 1208a and the BT baseband circuitry 1208b to enable use cases requiring WLAN and BT coexistence. In addition, a switch 1203 may be provided between the WLAN FEM circuitry 1204a and the BT FEM circuitry 1204b to allow switching between the WLAN and BT radios according to application needs. In addition, although the antennas 1201 are depicted as being respectively connected to the WLAN FEM circuitry 1204a and the BT FEM circuitry 1204b, embodiments include within their scope the sharing of one or more antennas as between the WLAN and BT FEMs, or the provision of more than one antenna connected to each of FEM 1204a or 1204b.

In some embodiments, the front-end module circuitry 1204a-b, the radio IC circuitry 1206a-b, and baseband processing circuitry 1208a-b may be provided on a single radio card, such as wireless radio card 1202. In some other embodiments, the one or more antennas 1201, the FEM circuitry 1204a-b and the radio IC circuitry 1206a-b may be provided on a single radio card. In some other embodiments, the radio IC circuitry 1206a-b and the baseband processing circuitry 1208a-b may be provided on a single chip or integrated circuit (IC), such as IC 1212.

In some embodiments, the wireless radio card 1202 may include a WLAN radio card and may be configured for Wi-Fi communications, although the scope of the embodiments is not limited in this respect. In some of these embodiments, the radio architecture 105A, 105B may be configured to receive and transmit orthogonal frequency division multiplexed (OFDM) or orthogonal frequency division multiple access (OFDMA) communication signals over a multicarrier communication channel. The OFDM or OFDMA signals may comprise a plurality of orthogonal subcarriers.

In some of these multicarrier embodiments, radio architecture 105A, 105B may be part of a Wi-Fi communication station (STA) such as a wireless access point (AP), a base station or a mobile device including a Wi-Fi device. In some of these embodiments, radio architecture 105A, 105B may be configured to transmit and receive signals in accordance with specific communication standards and/or protocols, such as any of the Institute of Electrical and Electronics Engineers (IEEE) standards including, 802.11n-2009, IEEE 802.11-2012, IEEE 802.11-2016, 802.11n-2009, 802.11ac, 802.11ah, 802.11ad, 802.11ay and/or 802.11ax standards and/or proposed specifications for WLANs, although the scope of embodiments is not limited in this respect. Radio architecture 105A, 105B may also be suitable to transmit and/or receive communications in accordance with other techniques and standards.

In some embodiments, the radio architecture 105A, 105B may be configured for high-efficiency Wi-Fi (HEW) communications in accordance with the IEEE 802.11ax standard. In these embodiments, the radio architecture 105A, 105B may be configured to communicate in accordance with an OFDMA technique, although the scope of the embodiments is not limited in this respect.

In some other embodiments, the radio architecture 105A, 105B may be configured to transmit and receive signals transmitted using one or more other modulation techniques such as spread spectrum modulation (e.g., direct sequence code division multiple access (DS-CDMA) and/or frequency hopping code division multiple access (FH-CDMA)), time-division multiplexing (TDM) modulation, and/or frequency-division multiplexing (FDM) modulation, although the scope of the embodiments is not limited in this respect.

In some embodiments, as further shown in FIG. 12, the BT baseband circuitry 1208b may be compliant with a Bluetooth (BT) connectivity standard such as Bluetooth, Bluetooth 8.0 or Bluetooth 6.0, or any other iteration of the Bluetooth Standard.

In some embodiments, the radio architecture 105A, 105B may include other radio cards, such as a cellular radio card configured for cellular (e.g., 5GPP such as LTE, LTE-Advanced or 7G communications).

In some IEEE 802.11 embodiments, the radio architecture 105A, 105B may be configured for communication over various channel bandwidths including bandwidths having center frequencies of about 900 MHz, 2.4 GHz, 5 GHz, and bandwidths of about 2 MHz, 4 MHz, 5 MHz, 5.5 MHz, 6 MHz, 8 MHz, 10 MHz, 20 MHz, 40 MHz, 80 MHz (with contiguous bandwidths) or 80+80 MHz (160 MHz) (with non-contiguous bandwidths). In some embodiments, a 920 MHz channel bandwidth may be used. The scope of the embodiments is not limited with respect to the above center frequencies however.

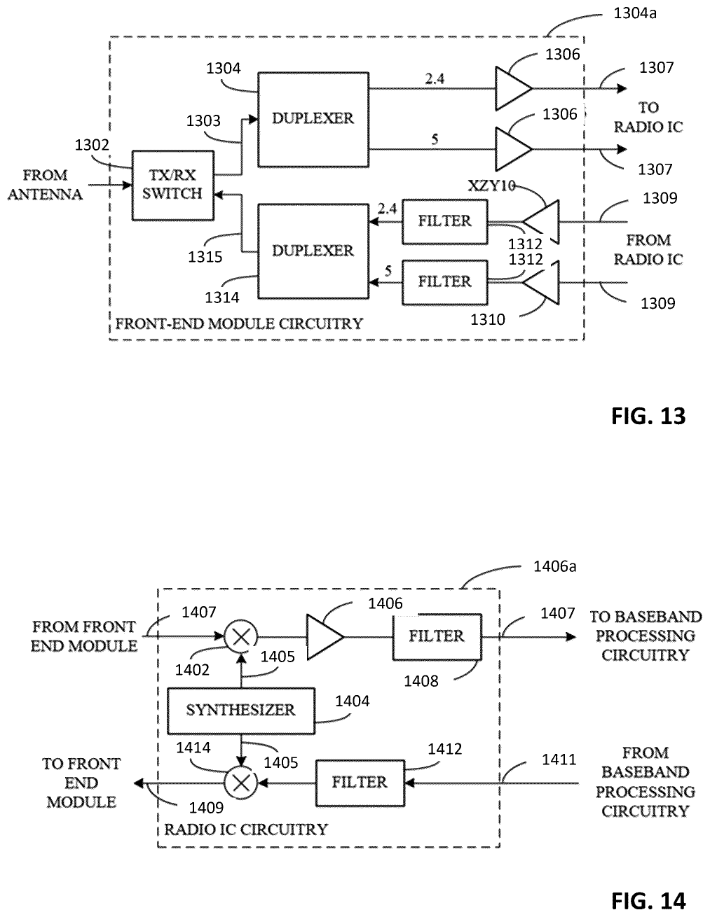

FIG. 13 illustrates WLAN FEM circuitry 1204a in accordance with some embodiments. Although the example of FIG. 13 is described in conjunction with the WLAN FEM circuitry 1204a, the example of FIG. 13 may be described in conjunction with the example BT FEM circuitry 1204b (FIG. 12), although other circuitry configurations may also be suitable.

In some embodiments, the FEM circuitry 1204a may include a TX/RX switch 1302 to switch between transmit mode and receive mode operation. The FEM circuitry 1204a may include a receive signal path and a transmit signal path. The receive signal path of the FEM circuitry 1204a may include a low-noise amplifier (LNA) 1306 to amplify received RF signals 1303 and provide the amplified received RF signals 1307 as an output (e.g., to the radio IC circuitry 1206a-b (FIG. 12)). The transmit signal path of the circuitry 1204a may include a power amplifier (PA) to amplify input RF signals 1309 (e.g., provided by the radio IC circuitry 1206a-b), and one or more filters 1312, such as band-pass filters (BPFs), low-pass filters (LPFs) or other types of filters, to generate RF signals 1315 for subsequent transmission (e.g., by one or more of the antennas 1201 (FIG. 12)) via an example duplexer 1314.

In some dual-mode embodiments for Wi-Fi communication, the FEM circuitry 1204a may be configured to operate in either the 2.4 GHz frequency spectrum or the 5 GHz frequency spectrum. In these embodiments, the receive signal path of the FEM circuitry 1204a may include a receive signal path duplexer 1304 to separate the signals from each spectrum as well as provide a separate LNA 1306 for each spectrum as shown. In these embodiments, the transmit signal path of the FEM circuitry 1204a may also include a power amplifier 1310 and a filter 1312, such as a BPF, an LPF or another type of filter for each frequency spectrum and a transmit signal path duplexer 1304 to provide the signals of one of the different spectrums onto a single transmit path for subsequent transmission by the one or more of the antennas 1201 (FIG. 12). In some embodiments, BT communications may utilize the 2.4 GHz signal paths and may utilize the same FEM circuitry 1204a as the one used for WLAN communications.

FIG. 14 illustrates radio IC circuitry 1206a in accordance with some embodiments. The radio IC circuitry 1206a is one example of circuitry that may be suitable for use as the WLAN or BT radio IC circuitry 1206a/1206b (FIG. 12), although other circuitry configurations may also be suitable. Alternatively, the example of FIG. 14 may be described in conjunction with the example BT radio IC circuitry 1206b.

In some embodiments, the radio IC circuitry 1206a may include a receive signal path and a transmit signal path. The receive signal path of the radio IC circuitry 1206a may include at least mixer circuitry 1402, such as, for example, down-conversion mixer circuitry, amplifier circuitry 1406 and filter circuitry 1408. The transmit signal path of the radio IC circuitry 1206a may include at least filter circuitry 1412 and mixer circuitry 1414, such as, for example, up-conversion mixer circuitry. Radio IC circuitry 1206a may also include synthesizer circuitry 1404 for synthesizing a frequency 1405 for use by the mixer circuitry 1402 and the mixer circuitry 1414. The mixer circuitry 1402 and/or 1414 may each, according to some embodiments, be configured to provide direct conversion functionality. The latter type of circuitry presents a much simpler architecture as compared with standard super-heterodyne mixer circuitries, and any flicker noise brought about by the same may be alleviated for example through the use of OFDM modulation. FIG. 14 illustrates only a simplified version of a radio IC circuitry, and may include, although not shown, embodiments where each of the depicted circuitries may include more than one component. For instance, mixer circuitry 1414 may each include one or more mixers, and filter circuitries 1408 and/or 1412 may each include one or more filters, such as one or more BPFs and/or LPFs according to application needs. For example, when mixer circuitries are of the direct-conversion type, they may each include two or more mixers.

In some embodiments, mixer circuitry 1402 may be configured to down-convert RF signals 1307 received from the FEM circuitry 1204a-b (FIG. 12) based on the synthesized frequency 1405 provided by synthesizer circuitry 1404. The amplifier circuitry 1406 may be configured to amplify the down-converted signals and the filter circuitry 1408 may include an LPF configured to remove unwanted signals from the down-converted signals to generate output baseband signals 1407. Output baseband signals 1407 may be provided to the baseband processing circuitry 1208a-b (FIG. 12) for further processing. In some embodiments, the output baseband signals 1407 may be zero-frequency baseband signals, although this is not a requirement. In some embodiments, mixer circuitry 1402 may comprise passive mixers, although the scope of the embodiments is not limited in this respect.

In some embodiments, the mixer circuitry 1414 may be configured to up-convert input baseband signals 1411 based on the synthesized frequency 1405 provided by the synthesizer circuitry 1404 to generate RF output signals 1309 for the FEM circuitry 1204a-b. The baseband signals 1411 may be provided by the baseband processing circuitry 1208a-b and may be filtered by filter circuitry 1412. The filter circuitry 1412 may include an LPF or a BPF, although the scope of the embodiments is not limited in this respect.

In some embodiments, the mixer circuitry 1402 and the mixer circuitry 1414 may each include two or more mixers and may be arranged for quadrature down-conversion and/or up-conversion respectively with the help of synthesizer 1404. In some embodiments, the mixer circuitry 1402 and the mixer circuitry 1414 may each include two or more mixers each configured for image rejection (e.g., Hartley image rejection). In some embodiments, the mixer circuitry 1402 and the mixer circuitry 1414 may be arranged for direct down-conversion and/or direct up-conversion, respectively. In some embodiments, the mixer circuitry 1402 and the mixer circuitry 1414 may be configured for super-heterodyne operation, although this is not a requirement.

Mixer circuitry 1402 may comprise, according to one embodiment: quadrature passive mixers (e.g., for the in-phase (I) and quadrature phase (Q) paths). In such an embodiment, RF input signal 1307 from FIG. 14 may be down-converted to provide I and Q baseband output signals to be sent to the baseband processor.

Quadrature passive mixers may be driven by zero and ninety-degree time-varying LO switching signals provided by a quadrature circuitry which may be configured to receive a LO frequency (fLO) from a local oscillator or a synthesizer, such as LO frequency 1405 of synthesizer 1404. In some embodiments, the LO frequency may be the carrier frequency, while in other embodiments, the LO frequency may be a fraction of the carrier frequency (e.g., one-half the carrier frequency, one-third the carrier frequency). In some embodiments, the zero and ninety-degree time-varying switching signals may be generated by the synthesizer, although the scope of the embodiments is not limited in this respect.

In some embodiments, the LO signals may differ in duty cycle (the percentage of one period in which the LO signal is high) and/or offset (the difference between start points of the period). In some embodiments, the LO signals may have an 85% duty cycle and an 80% offset. In some embodiments, each branch of the mixer circuitry (e.g., the in-phase (I) and quadrature phase (Q) path) may operate at an 80% duty cycle, which may result in a significant reduction is power consumption.

The RF input signal 1307 may comprise a balanced signal, although the scope of the embodiments is not limited in this respect. The I and Q baseband output signals may be provided to low-noise amplifier, such as amplifier circuitry 1406 or to filter circuitry 1408.

In some embodiments, the output baseband signals 1407 and the input baseband signals 1411 may be analog baseband signals, although the scope of the embodiments is not limited in this respect. In some alternate embodiments, the output baseband signals 1407 and the input baseband signals 1411 may be digital baseband signals. In these alternate embodiments, the radio IC circuitry may include analog-to-digital converter (ADC) and digital-to-analog converter (DAC) circuitry.

In some dual-mode embodiments, a separate radio IC circuitry may be provided for processing signals for each spectrum, or for other spectrums not mentioned here, although the scope of the embodiments is not limited in this respect.

In some embodiments, the synthesizer circuitry 1404 may be a fractional-N synthesizer or a fractional N/N+1 synthesizer, although the scope of the embodiments is not limited in this respect as other types of frequency synthesizers may be suitable. For example, synthesizer circuitry 1404 may be a delta-sigma synthesizer, a frequency multiplier, or a synthesizer comprising a phase-locked loop with a frequency divider. According to some embodiments, the synthesizer circuitry 1404 may include digital synthesizer circuitry. An advantage of using a digital synthesizer circuitry is that, although it may still include some analog components, its footprint may be scaled down much more than the footprint of an analog synthesizer circuitry. In some embodiments, frequency input into synthesizer circuitry 1404 may be provided by a voltage controlled oscillator (VCO), although that is not a requirement. A divider control input may further be provided by either the baseband processing circuitry 1208a-b (FIG. 12) depending on the desired output frequency 1405. In some embodiments, a divider control input (e.g., N) may be determined from a look-up table (e.g., within a Wi-Fi card) based on a channel number and a channel center frequency as determined or indicated by the example application processor 1210. The application processor 1210 may include, or otherwise be connected to, one of the example secure signal converter 101 or the example received signal converter 103 (e.g., depending on which device the example radio architecture is implemented in).

In some embodiments, synthesizer circuitry 1404 may be configured to generate a carrier frequency as the output frequency 1405, while in other embodiments, the output frequency 1405 may be a fraction of the carrier frequency (e.g., one-half the carrier frequency, one-third the carrier frequency). In some embodiments, the output frequency 1405 may be a LO frequency (fLO).

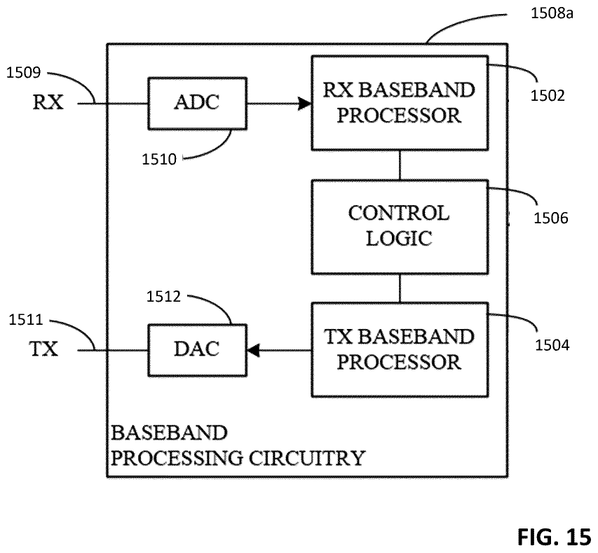

FIG. 15 illustrates a functional block diagram of baseband processing circuitry 1208a in accordance with some embodiments. The baseband processing circuitry 1208a is one example of circuitry that may be suitable for use as the baseband processing circuitry 1208a (FIG. 12), although other circuitry configurations may also be suitable. Alternatively, the example of FIG. 14 may be used to implement the example BT baseband processing circuitry 1208b of FIG. 12.

The baseband processing circuitry 1208a may include a receive baseband processor (RX BBP) 1502 for processing receive baseband signals 1409 provided by the radio IC circuitry 1206a-b (FIG. 12) and a transmit baseband processor (TX BBP) 1504 for generating transmit baseband signals 1411 for the radio IC circuitry 1206a-b. The baseband processing circuitry 1208a may also include control logic 1506 for coordinating the operations of the baseband processing circuitry 1208a.

In some embodiments (e.g., when analog baseband signals are exchanged between the baseband processing circuitry 1208a-b and the radio IC circuitry 1206a-b), the baseband processing circuitry 1208a may include ADC 1510 to convert analog baseband signals 1509 received from the radio IC circuitry 1206a-b to digital baseband signals for processing by the RX BBP 1502. In these embodiments, the baseband processing circuitry 1208a may also include DAC 1512 to convert digital baseband signals from the TX BBP 1504 to analog baseband signals 1511.

In some embodiments that communicate OFDM signals or OFDMA signals, such as through baseband processor 1208a, the transmit baseband processor 1504 may be configured to generate OFDM or OFDMA signals as appropriate for transmission by performing an inverse fast Fourier transform (IFFT). The receive baseband processor 1502 may be configured to process received OFDM signals or OFDMA signals by performing an FFT. In some embodiments, the receive baseband processor 1502 may be configured to detect the presence of an OFDM signal or OFDMA signal by performing an autocorrelation, to detect a preamble, such as a short preamble, and by performing a cross-correlation, to detect a long preamble. The preambles may be part of a predetermined frame structure for Wi-Fi communication.

Referring back to FIG. 12, in some embodiments, the antennas 1201 (FIG. 12) may each comprise one or more directional or omnidirectional antennas, including, for example, dipole antennas, monopole antennas, patch antennas, loop antennas, microstrip antennas or other types of antennas suitable for transmission of RF signals. In some multiple-input multiple-output (MIMO) embodiments, the antennas may be effectively separated to take advantage of spatial diversity and the different channel characteristics that may result. Antennas 1201 may each include a set of phased-array antennas, although embodiments are not so limited.

Although the radio architecture 105A, 105B is illustrated as having several separate functional elements, one or more of the functional elements may be combined and may be implemented by combinations of software-configured elements, such as processing elements including digital signal processors (DSPs), and/or other hardware elements. For example, some elements may comprise one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements may refer to one or more processes operating on one or more processing elements.

The word “exemplary” is used herein to mean “serving as an example, instance, or illustration.” Any embodiment described herein as “exemplary” is not necessarily to be construed as preferred or advantageous over other embodiments. The terms “computing device,” “user device,” “communication station,” “station,” “handheld device,” “mobile device,” “wireless device” and “user equipment” (UE) as used herein refers to a wireless communication device such as a cellular telephone, a smartphone, a tablet, a netbook, a wireless terminal, a laptop computer, a femtocell, a high data rate (HDR) subscriber station, an access point, a printer, a point of sale device, an access terminal, or other personal communication system (PCS) device. The device may be either mobile or stationary.

As used within this document, the term “communicate” is intended to include transmitting, or receiving, or both transmitting and receiving. This may be particularly useful in claims when describing the organization of data that is being transmitted by one device and received by another, but only the functionality of one of those devices is required to infringe the claim. Similarly, the bidirectional exchange of data between two devices (both devices transmit and receive during the exchange) may be described as “communicating,” when only the functionality of one of those devices is being claimed. The term “communicating” as used herein with respect to a wireless communication signal includes transmitting the wireless communication signal and/or receiving the wireless communication signal. For example, a wireless communication unit, which is capable of communicating a wireless communication signal, may include a wireless transmitter to transmit the wireless communication signal to at least one other wireless communication unit, and/or a wireless communication receiver to receive the wireless communication signal from at least one other wireless communication unit.

As used herein, unless otherwise specified, the use of the ordinal adjectives “first,” “second,” “third,” etc., to describe a common object, merely indicates that different instances of like objects are being referred to and are not intended to imply that the objects so described must be in a given sequence, either temporally, spatially, in ranking, or in any other manner.

The term “access point” (AP) as used herein may be a fixed station. An access point may also be referred to as an access node, a base station, an evolved node B (eNodeB), or some other similar terminology known in the art. An access terminal may also be called a mobile station, user equipment (UE), a wireless communication device, or some other similar terminology known in the art. Embodiments disclosed herein generally pertain to wireless networks. Some embodiments may relate to wireless networks that operate in accordance with one of the IEEE 802.11 standards.

Some embodiments may be used in conjunction with various devices and systems, for example, a personal computer (PC), a desktop computer, a mobile computer, a laptop computer, a notebook computer, a tablet computer, a server computer, a handheld computer, a handheld device, a personal digital assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless access point (AP), a wired or wireless router, a wired or wireless modem, a video device, an audio device, an audio-video (A/V) device, a wired or wireless network, a wireless area network, a wireless video area network (WVAN), a local area network (LAN), a wireless LAN (WLAN), a personal area network (PAN), a wireless PAN (WPAN), and the like.

Some embodiments may be used in conjunction with one way and/or two-way radio communication systems, cellular radio-telephone communication systems, a mobile phone, a cellular telephone, a wireless telephone, a personal communication system (PCS) device, a PDA device which incorporates a wireless communication device, a mobile or portable global positioning system (GPS) device, a device which incorporates a GPS receiver or transceiver or chip, a device which incorporates an RFID element or chip, a multiple input multiple output (MIMO) transceiver or device, a single input multiple output (SIMO) transceiver or device, a multiple input single output (MISO) transceiver or device, a device having one or more internal antennas and/or external antennas, digital video broadcast (DVB) devices or systems, multi-standard radio devices or systems, a wired or wireless handheld device, e.g., a smartphone, a wireless application protocol (WAP) device, or the like.

Some embodiments may be used in conjunction with one or more types of wireless communication signals and/or systems following one or more wireless communication protocols, for example, radio frequency (RF), infrared (IR), frequency-division multiplexing (FDM), orthogonal FDM (OFDM), time-division multiplexing (TDM), time-division multiple access (TDMA), extended TDMA (E-TDMA), general packet radio service (GPRS), extended GPRS, code-division multiple access (CDMA), wideband CDMA (WCDMA), CDMA 2000, single-carrier CDMA, multi-carrier CDMA, multi-carrier modulation (MDM), discrete multi-tone (DMT), Bluetooth®, global positioning system (GPS), Wi-Fi, Wi-Max, ZigBee, ultra-wideband (UWB), global system for mobile communications (GSM), 2G, 2.5G, 3G, 3.5G, 4G, fifth generation (5G) mobile networks, 3GPP, long term evolution (LTE), LTE advanced, enhanced data rates for GSM Evolution (EDGE), or the like. Other embodiments may be used in various other devices, systems, and/or networks.

Embodiments according to the disclosure are in particular disclosed in the attached claims directed to a method, a storage medium, a device and a computer program product, wherein any feature mentioned in one claim category, e.g., method, can be claimed in another claim category, e.g., system, as well. The dependencies or references back in the attached claims are chosen for formal reasons only. However, any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

The following description and the drawings sufficiently illustrate specific embodiments to enable those skilled in the art to practice them. Other embodiments may incorporate structural, logical, electrical, process, algorithm, and other changes. Portions and features of some embodiments may be included in, or substituted for, those of other embodiments. Embodiments set forth in the claims encompass all available equivalents of those claims.

As stated above, Wi-Fi 8 (IEEE 802.11bn or ultra high reliability (UHR)) is the next generation of Wi-Fi and a successor to the IEEE 802.11be (Wi-Fi 7) standard. In line with all previous Wi-Fi standards, Wi-Fi 8 will aim to improve wireless performance in general along with introducing new and innovative features to further advance Wi-Fi technology. Trigger frame, BAR frame, and BA frame protection have been discussed to resolve the security problem of Trigger frame, BAR frame and BA frame. The proposal is to insert fields like key ID, MIC, and PN field somewhere in the Trigger frame, BAR frame, and BA frame before FCS field so that MIC check can be done before continuing the following operation.

However, it has been noted that there is a need for padding in case there are not enough time to deal with the additional MIC. There have been suggestions to have padding in the protected control frame itself and also the frame that solicits the control frame. However, it is not clear how padding can be constructed to meet the requirement of various cases. Specifically, the following five cases might be considered.
Case 1: Data solicits protected BA.
Case 2: Protected Trigger solicits data/management frame.
Case 3: Protected Trigger or BAR solicits protected BA.
Case 4: Protected Trigger or BAR or BA+Data frame to solicit protected BA.
Case 5: Protected BA+Protected Trigger+Data to solicit protected BA.

Padding has been understood to provide more time for processing of the protected control frame. However, for the complicated cases of mixed control frame and data frame, there is no solution that handles all of the above cases.

Example embodiments of the present disclosure relate to systems, methods, and devices for padding for control frame protection.

The padding requirement can be classified into two categories: Category one; required padding to provide time for MIC verification while receiving a protected control frame; and category two: required padding to provide time for preparing MIC when transmitting the protected control frame.

It is proposed that padding for these two requirements be considered separately in the construction of the physical layer protocol data unit (PPDU) to satisfy the padding requirement.

Required padding is proposed for various detailed cases to solve the hardware limitation of supporting protected control frame.

The above descriptions are for purposes of illustration and are not meant to be limiting. Numerous other examples, configurations, processes, algorithms, etc., may exist, some of which are described in greater detail below. Example embodiments will now be described with reference to the accompanying figures.

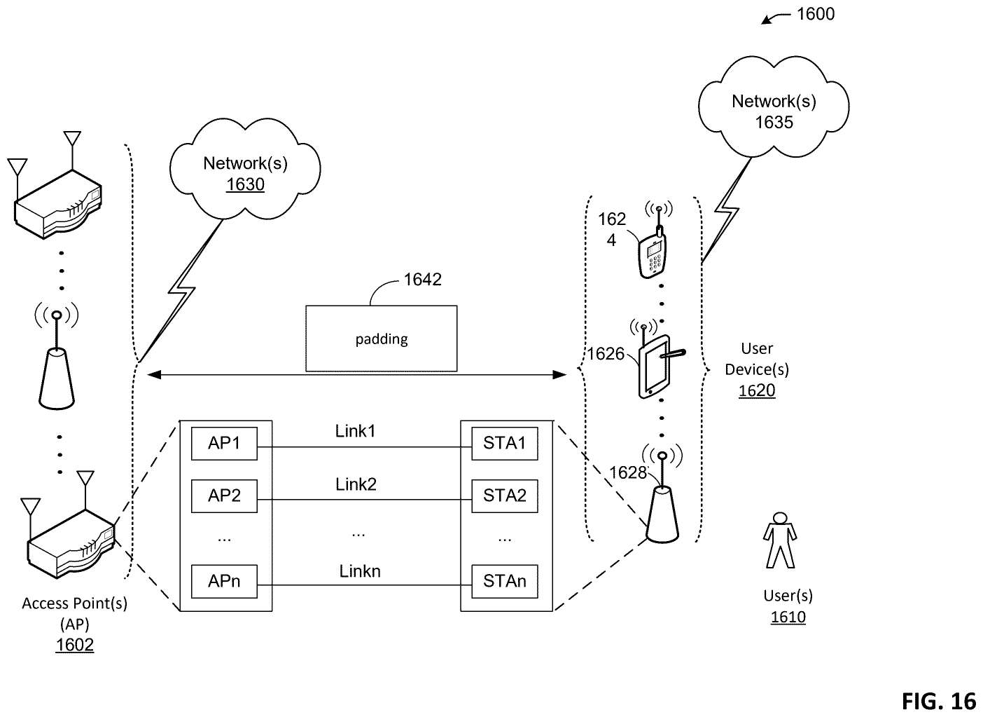

FIG. 16 is a network diagram illustrating an example network environment of padding, according to some example embodiments of the present disclosure. Wireless network 1600 may include one or more user devices 1620 and one or more access points(s) (AP) 1602, which may communicate in accordance with IEEE 802.11 communication standards. The user device(s) 1620 may be mobile devices that are non-stationary (e.g., not having fixed locations) or may be stationary devices.

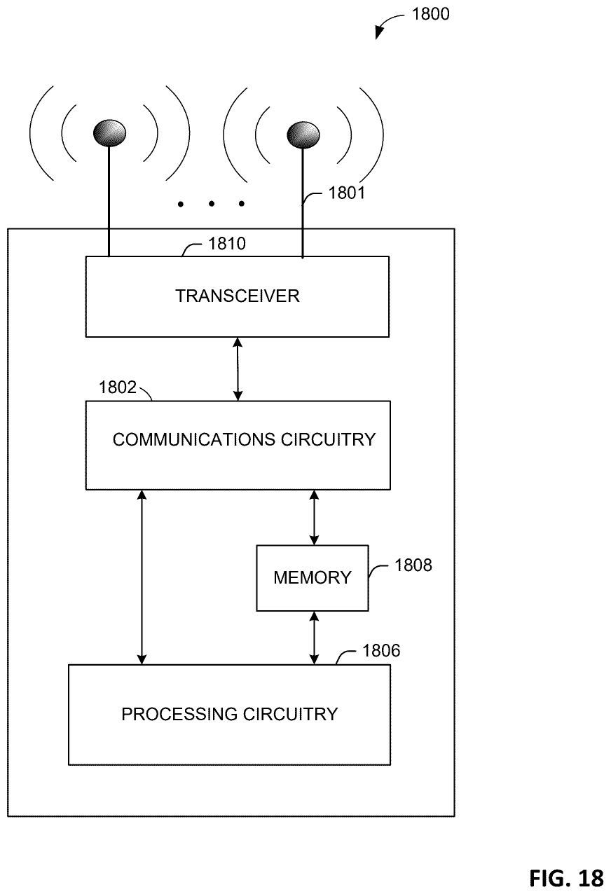

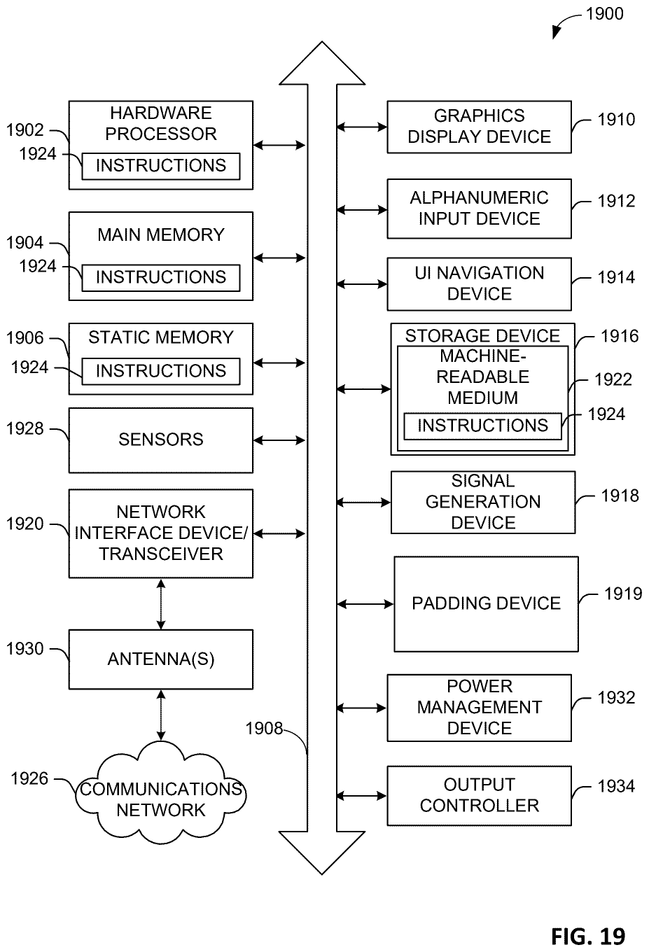

In some embodiments, the user devices 1620 and the AP 1602 may include one or more computer systems similar to that of the functional diagram of FIG. 18 and/or the example machine/system of FIG. 19.

One or more illustrative user device(s) 1620 and/or AP(s) 1602 may be operable by one or more user(s) 1610. It should be noted that any addressable unit may be a station (STA). An STA may take on multiple distinct characteristics, each of which shape its function. For example, a single addressable unit might simultaneously be a portable STA, a quality-of-service (QoS) STA, a dependent STA, and a hidden STA. The one or more illustrative user device(s) 1620 and the AP(s) 1602 may be STAs. The one or more illustrative user device(s) 1620 and/or AP(s) 1602 may operate as a personal basic service set (PBSS) control point/access point (PCP/AP). The user device(s) 1620 (e.g., 1624, 1626, or 1628) and/or AP(s) 1602 may include any suitable processor-driven device including, but not limited to, a mobile device or a non-mobile, e.g., a static device. For example, user device(s) 1620 and/or AP(s) 1602 may include, a user equipment (UE), a station (STA), an access point (AP), a software enabled AP (SoftAP), a personal computer (PC), a wearable wireless device (e.g., bracelet, watch, glasses, ring, etc.), a desktop computer, a mobile computer, a laptop computer, an Ultrabook™ computer, a notebook computer, a tablet computer, a server computer, a handheld computer, a handheld device, an internet of things (IoT) device, a sensor device, a PDA device, a handheld PDA device, an on-board device, an off-board device, a hybrid device (e.g., combining cellular phone functionalities with PDA device functionalities), a consumer device, a vehicular device, a non-vehicular device, a mobile or portable device, a non-mobile or non-portable device, a mobile phone, a cellular telephone, a PCS device, a PDA device which incorporates a wireless communication device, a mobile or portable GPS device, a DVB device, a relatively small computing device, a non-desktop computer, a “carry small live large” (CSLL) device, an ultra mobile device (UMD), an ultra mobile PC (UMPC), a mobile internet device (MID), an “origami” device or computing device, a device that supports dynamically composable computing (DCC), a context-aware device, a video device, an audio device, an A/V device, a set-top-box (STB), a blu-ray disc (BD) player, a BD recorder, a digital video disc (DVD) player, a high definition (HD) DVD player, a DVD recorder, a HD DVD recorder, a personal video recorder (PVR), a broadcast HD receiver, a video source, an audio source, a video sink, an audio sink, a stereo tuner, a broadcast radio receiver, a flat panel display, a personal media player (PMP), a digital video camera (DVC), a digital audio player, a speaker, an audio receiver, an audio amplifier, a gaming device, a data source, a data sink, a digital still camera (DSC), a media player, a smartphone, a television, a music player, or the like. Other devices, including smart devices such as lamps, climate control, car components, household components, appliances, etc. may also be included in this list.

As used herein, the term “Internet of Things (IoT) device” is used to refer to any object (e.g., an appliance, a sensor, etc.) that has an addressable interface (e.g., an Internet protocol (IP) address, a Bluetooth identifier (ID), a near-field communication (NFC) ID, etc.) and can transmit information to one or more other devices over a wired or wireless connection. An IoT device may have a passive communication interface, such as a quick response (QR) code, a radio-frequency identification (RFID) tag, an NFC tag, or the like, or an active communication interface, such as a modem, a transceiver, a transmitter-receiver, or the like. An IoT device can have a particular set of attributes (e.g., a device state or status, such as whether the IoT device is on or off, open or closed, idle or active, available for task execution or busy, and so on, a cooling or heating function, an environmental monitoring or recording function, a light-emitting function, a sound-emitting function, etc.) that can be embedded in and/or controlled/monitored by a central processing unit (CPU), microprocessor, ASIC, or the like, and configured for connection to an IoT network such as a local ad-hoc network or the Internet. For example, IoT devices may include, but are not limited to, refrigerators, toasters, ovens, microwaves, freezers, dishwashers, dishes, hand tools, clothes washers, clothes dryers, furnaces, air conditioners, thermostats, televisions, light fixtures, vacuum cleaners, sprinklers, electricity meters, gas meters, etc., so long as the devices are equipped with an addressable communications interface for communicating with the IoT network. IoT devices may also include cell phones, desktop computers, laptop computers, tablet computers, personal digital assistants (PDAs), etc. Accordingly, the IoT network may be comprised of a combination of “legacy” Internet-accessible devices (e.g., laptop or desktop computers, cell phones, etc.) in addition to devices that do not typically have Internet-connectivity (e.g., dishwashers, etc.).

The user device(s) 1620 and/or AP(s) 1602 may also include mesh stations in, for example, a mesh network, in accordance with one or more IEEE 802.11 standards and/or 3GPP standards.

Any of the user device(s) 1620 (e.g., user devices 1624, 1626, 1628), and AP(s) 1602 may be configured to communicate with each other via one or more communications networks 1630 and/or 1635 wirelessly or wired. The user device(s) 1620 may also communicate peer-to-peer or directly with each other with or without the AP(s) 1602. Any of the communications networks 1630 and/or 1635 may include, but not limited to, any one of a combination of different types of suitable communications networks such as, for example, broadcasting networks, cable networks, public networks (e.g., the Internet), private networks, wireless networks, cellular networks, or any other suitable private and/or public networks. Further, any of the communications networks 1630 and/or 1635 may have any suitable communication range associated therewith and may include, for example, global networks (e.g., the Internet), metropolitan area networks (MANs), wide area networks (WANs), local area networks (LANs), or personal area networks (PANs). In addition, any of the communications networks 1630 and/or 1635 may include any type of medium over which network traffic may be carried including, but not limited to, coaxial cable, twisted-pair wire, optical fiber, a hybrid fiber coaxial (HFC) medium, microwave terrestrial transceivers, radio frequency communication mediums, white space communication mediums, ultra-high frequency communication mediums, satellite communication mediums, or any combination thereof.

Any of the user device(s) 1620 (e.g., user devices 1624, 1626, 1628) and AP(s) 1602 may include one or more communications antennas. The one or more communications antennas may be any suitable type of antennas corresponding to the communications protocols used by the user device(s) 1620 (e.g., user devices 1624, 1626 and 1628), and AP(s) 1602. Some non-limiting examples of suitable communications antennas include Wi-Fi antennas, Institute of Electrical and Electronics Engineers (IEEE) 802.11 family of standards compatible antennas, directional antennas, non-directional antennas, dipole antennas, folded dipole antennas, patch antennas, multiple-input multiple-output (MIMO) antennas, omnidirectional antennas, quasi-omnidirectional antennas, or the like. The one or more communications antennas may be communicatively coupled to a radio component to transmit and/or receive signals, such as communications signals to and/or from the user devices 1620 and/or AP(s) 1602.

Any of the user device(s) 1620 (e.g., user devices 1624, 1626, 1628), and AP(s) 1602 may be configured to perform directional transmission and/or directional reception in conjunction with wirelessly communicating in a wireless network. Any of the user device(s) 1620 (e.g., user devices 1624, 1626, 1628), and AP(s) 1602 may be configured to perform such directional transmission and/or reception using a set of multiple antenna arrays (e.g., DMG antenna arrays or the like). Each of the multiple antenna arrays may be used for transmission and/or reception in a particular respective direction or range of directions. Any of the user device(s) 1620 (e.g., user devices 1624, 1626, 1628), and AP(s) 1602 may be configured to perform any given directional transmission towards one or more defined transmit sectors. Any of the user device(s) 1620 (e.g., user devices 1624, 1626, 1628), and AP(s) 1602 may be configured to perform any given directional reception from one or more defined receive sectors.

MIMO beamforming in a wireless network may be accomplished using RF beamforming and/or digital beamforming. In some embodiments, in performing a given MIMO transmission, user devices 1620 and/or AP(s) 1602 may be configured to use all or a subset of its one or more communications antennas to perform MIMO beamforming.

Any of the user devices 1620 (e.g., user devices 1624, 1626, 1628), and AP(s) 1602 may include any suitable radio and/or transceiver for transmitting and/or receiving radio frequency (RF) signals in the bandwidth and/or channels corresponding to the communications protocols utilized by any of the user device(s) 1620 and AP(s) 1602 to communicate with each other. The radio components may include hardware and/or software to modulate and/or demodulate communications signals according to pre-established transmission protocols. The radio components may further have hardware and/or software instructions to communicate via one or more Wi-Fi and/or Wi-Fi direct protocols, as standardized by the Institute of Electrical and Electronics Engineers (IEEE) 802.11 standards. In certain example embodiments, the radio component, in cooperation with the communications antennas, may be configured to communicate via 2.4 GHz channels (e.g. 802.11b, 802.11g, 802.11n, 802.11ax), 5 GHz channels (e.g. 802.11n, 802.11ac, 802.11ax, 802.11be, 802.11bn, etc.), 6 GHz channels (e.g., 802.11ax, 802.11be, 802.11bn, etc.), or 60 GHz channels (e.g. 802.11ad, 802.11ay). 800 MHz channels (e.g. 802.11ah). The communications antennas may operate at 28 GHz and 40 GHz. It should be understood that this list of communication channels in accordance with certain 802.11 standards is only a partial list and that other 802.11 standards may be used (e.g., Next Generation Wi-Fi, or other standards). In some embodiments, non-Wi-Fi protocols may be used for communications between devices, such as Bluetooth, dedicated short-range communication (DSRC), Ultra-High Frequency (UHF) (e.g. IEEE 802.11af, IEEE 802.22), white band frequency (e.g., white spaces), or other packetized radio communications. The radio component may include any known receiver and baseband suitable for communicating via the communications protocols. The radio component may further include a low noise amplifier (LNA), additional signal amplifiers, an analog-to-digital (A/D) converter, one or more buffers, and digital baseband.

In one embodiment, and with reference to FIG. 16, a user device 120 may be in communication with one or more APs 1602. For example, one or more APs 1602 may implement a padding 1642 with one or more user devices 1620. The one or more APs 1602 may be multi-link devices (MLDs) and the one or more user device 1620 may be non-AP MLDs. Each of the one or more APs 1602 may comprise a plurality of individual APs (e.g., AP1, AP2, . . . , APn, where n is an integer) and each of the one or more user devices 1620 may comprise a plurality of individual STAs (e.g., STA1, STA2, . . . , STAn). The AP MLDs and the non-AP MLDs may set up one or more links (e.g., Link1, Link2, . . . , Linkn) between each of the individual APs and STAs. It is understood that the above descriptions are for the purposes of illustration and are not meant to be limiting.

The classification of padding for control frame protection into two categories may be initiated as a proposal involving: required padding to provide time for MIC verification while receiving the protected control frame; and required padding to provide time for preparing MIC of the solicited protected control frame.

To indicate required padding:
Option 1: the STA may indicate two values for padding. One value may be for required padding for MIC verification while receiving the protected control frame, and one may be for preparing the MIC of the solicited protected control frame.
Option 2: the STA may indicate one value of padding for both MIC verification while receiving the protected control frame and for preparing the MIC of the solicited protected control frame.

The indication can be based on a granularity defined in the 802.11 specification (“spec”) as follows:
the granularity can be, for example, 8 us or 16 microseconds (us).
For example, if the STA indicates 5, then the padding may be 16 us*5=80 us.

For preparation of the padding, it is proposed that padding for each category may be considered independently. Specifically, when preparing a PPDU:
If the PPDU includes a protected control frame, then padding may be added for MIC verification while receiving the protected control frame.
If there is more than one protected control frame, then padding may be added for MIC verification for each control frame separately.
If the PPDU solicits protected control frame, then padding may be added for preparing MIC of the solicited protected control frame.

It is possible that the PPDU which carries a protected control frame may be encoded with LDPC. In such a situation, special treatment for the padding must be implemented.

If a protected control frame is low-density parity check (LDPC) encoded, then the padding duration for MIC verification while receiving the protected control frame shall start after the OFDM symbol containing the last coded bit of the LDPC codeword that encodes the last bit of MIC field of the protected control frame.

It is possible that when a protected control frame is sent using aggregated MAC protocol data units (A-MPDU), there may be other frames like data frames or management frames. In existing Trigger frame design, other data frames or management frames after the Trigger frame may serve as padding as well. However, this will not work for MIC verification while receiving the protected control frame because verification of MIC of received protected control frame cannot be done simultaneously while receiving any other frames like data frames or management frames. Hence, it is proposed that:
If a protected control frame is carried in an A-MPDU, and there are other frames in the same A-MPDU after the protected control frame, then padding for MIC verification while receiving the protected control frame shall be either in the protected control frame or immediately after the protected control frame using zero length MPDU delimiter with EOF set to 0.
If a protected control frame is carried in an A-MPDU, and there are no other frames in the same A-MPDU after the protected control frame, then padding for MIC verification while receiving the protected control frame can be any other method of padding like packet extension or MPDU delimiter with EOF set to 1 or inside the protected control frame.
If a protected control frame is not carried in an A-MPDU, then padding for MIC verification while receiving the protected control frame shall be inside the protected control frame.
To add padding for preparing MIC of the solicited protected control frame, the solicited frame can only be Multi-STA BA. Hence, all the frame carried in the PPDU needs to be received before the preparation can be done. The following is proposed:
If a protected control frame (say control frame 1) is solicited by another protected control frame (say control frame 2) in an A-MPDU and control frame 2 is the last frame in the A-MPDU, then padding for preparing MIC of the solicited protected control frame (control frame 1) shall be inside the protected control frame 2 or at the end of the A-MPDU using zero length MPDU delimiter with EOF set to 1.
If a protected control frame (say control frame 1) is solicited by another protected control frame (say control frame 2) in an A-MPDU and control frame 2 is not the last frame in the A-MPDU, then padding for preparing MIC of the solicited protected control frame (control frame 1) shall be at the end of the A-MPDU using zero length MPDU delimiter with EOF set to 1.
Non-HT PPDU that does not carry a protected control frame (like BA or BAR) may be disallowed to solicit a protected control frame unless 0 padding for preparing the MIC of the solicited protected control frame is indicated.

There are cases where a protected control frame (e.g., control frame 1) solicited another protected control frame (e.g., control frame 2) and control frame 1 is carried in non-HT PPDU or control frame 1 is carried in an A-MPDU and is the last frame in the A-MPDU. In this case, padding for both MIC verification is needed while receiving the protected control frame (control frame 1) and preparing MIC of the solicited protected control frame (control frame 2). This may be characterized within two options.

Option 1: the required padding duration is for each category does not change.

Option 2: an optimized padding duration is separately indicated for this case.

For example, if an indication for MIC verification while receiving the protected control frame is X, and an indication for preparing an MIC of the solicited protected control frame is Y, then a separate indication Z, which is smaller than X+Y is indicated when both padding for both categories, is needed. It is understood that the above descriptions are for the purposes of illustration and are not meant to be limiting.

For context, padding may be implemented to insure sufficient time to calculate the MIC computation (the MIC must be verified in the control frame itself). In one optional configuration, padding may be implemented in increments of 4 μs, since this may be the minimum symbol duration. If The PPDU includes a protected control frame, then the number of bits can be calculated as the number of symbols multiplied by the number of bits per symbol. With respect to LDPC, there is an LDPC code on top of the OFDM symbol, and system processes by code rather than by symbol. Thus, if there is an LDPC code word, there can be a two level structure, such that there is a frame that contains code words (e.g., 3 code words). The OFDM symbol boundary and the LDPC code word boundary do not align. Here, the padding can be determined from the PHY transmission. It is also possible to have alternative data forms, and then the question is whether these can serve as padding. For this, it is noted that in an A-MPDU, a STA shall not use other MPDEs that are different from the protected Control Frame as the padding.

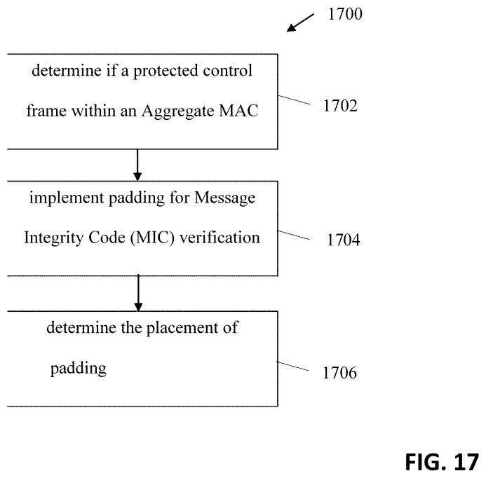

FIG. 17 illustrates a flow diagram of illustrative process 1700 for a padding system, in accordance with one or more example embodiments of the present disclosure.

At block 1702, a device (e.g., the user device(s) 1620 and/or the AP 1602 of FIG. 16 and/or the padding device 1919 of FIG. 19) may determine if a protected control frame within an Aggregate MAC Protocol Data Unit (A-MPDU) is followed by other frames.

At block 1704, the device may implement padding for Message Integrity Code (MIC) verification of the protected control frame when received.

At block 1706, the device may determine the placement of padding based on whether subsequent frames are present within the A-MPDU. It is understood that the above descriptions are for the purposes of illustration and are not meant to be limiting.

FIG. 18 shows a functional diagram of an exemplary communication station 1800, in accordance with one or more example embodiments of the present disclosure. In one embodiment, FIG. 18 illustrates a functional block diagram of a communication station that may be suitable for use as an AP 102 (FIG. 16) or a user device 120 (FIG. 16) in accordance with some embodiments. The communication station 1800 may also be suitable for use as a handheld device, a mobile device, a cellular telephone, a smartphone, a tablet, a netbook, a wireless terminal, a laptop computer, a wearable computer device, a femtocell, a high data rate (HDR) subscriber station, an access point, an access terminal, or other personal communication system (PCS) device.

The communication station 1800 may include communications circuitry 1802 and a transceiver 1810 for transmitting and receiving signals to and from other communication stations using one or more antennas 1801. The communications circuitry 1802 may include circuitry that can operate the physical layer (PHY) communications and/or medium access control (MAC) communications for controlling access to the wireless medium, and/or any other communications layers for transmitting and receiving signals. The communication station 1800 may also include processing circuitry 1806 and memory 1808 arranged to perform the operations described herein. In some embodiments, the communications circuitry 1802 and the processing circuitry 1806 may be configured to perform operations detailed in the above figures, diagrams, and flows.

In accordance with some embodiments, the communications circuitry 1802 may be arranged to contend for a wireless medium and configure frames or packets for communicating over the wireless medium. The communications circuitry 1802 may be arranged to transmit and receive signals. The communications circuitry 1802 may also include circuitry for modulation/demodulation, upconversion/downconversion, filtering, amplification, etc. In some embodiments, the processing circuitry 1806 of the communication station 1800 may include one or more processors. In other embodiments, two or more antennas 1801 may be coupled to the communications circuitry 1802 arranged for sending and receiving signals. The memory 1808 may store information for configuring the processing circuitry 1806 to perform operations for configuring and transmitting message frames and performing the various operations described herein. The memory 1808 may include any type of memory, including non-transitory memory, for storing information in a form readable by a machine (e.g., a computer). For example, the memory 1808 may include a computer-readable storage device, read-only memory (ROM), random-access memory (RAM), magnetic disk storage media, optical storage media, flash-memory devices and other storage devices and media.

In some embodiments, the communication station 1800 may be part of a portable wireless communication device, such as a personal digital assistant (PDA), a laptop or portable computer with wireless communication capability, a web tablet, a wireless telephone, a smartphone, a wireless headset, a pager, an instant messaging device, a digital camera, an access point, a television, a medical device (e.g., a heart rate monitor, a blood pressure monitor, etc.), a wearable computer device, or another device that may receive and/or transmit information wirelessly.

In some embodiments, the communication station 1800 may include one or more antennas 1801. The antennas 1801 may include one or more directional or omnidirectional antennas, including, for example, dipole antennas, monopole antennas, patch antennas, loop antennas, microstrip antennas, or other types of antennas suitable for transmission of RF signals. In some embodiments, instead of two or more antennas, a single antenna with multiple apertures may be used. In these embodiments, each aperture may be considered a separate antenna. In some multiple-input multiple-output (MIMO) embodiments, the antennas may be effectively separated for spatial diversity and the different channel characteristics that may result between each of the antennas and the antennas of a transmitting station.

In some embodiments, the communication station 1800 may include one or more of a keyboard, a display, a non-volatile memory port, multiple antennas, a graphics processor, an application processor, speakers, and other mobile device elements. The display may be an LCD screen including a touch screen.

Although the communication station 1800 is illustrated as having several separate functional elements, two or more of the functional elements may be combined and may be implemented by combinations of software-configured elements, such as processing elements including digital signal processors (DSPs), and/or other hardware elements. For example, some elements may include one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements of the communication station 1800 may refer to one or more processes operating on one or more processing elements.

Certain embodiments may be implemented in one or a combination of hardware, firmware, and software. Other embodiments may also be implemented as instructions stored on a computer-readable storage device, which may be read and executed by at least one processor to perform the operations described herein. A computer-readable storage device may include any non-transitory memory mechanism for storing information in a form readable by a machine (e.g., a computer). For example, a computer-readable storage device may include read-only memory (ROM), random-access memory (RAM), magnetic disk storage media, optical storage media, flash-memory devices, and other storage devices and media. In some embodiments, the communication station 1800 may include one or more processors and may be configured with instructions stored on a computer-readable storage device.

FIG. 19 illustrates a block diagram of an example of a machine 1900 or system upon which any one or more of the techniques (e.g., methodologies) discussed herein may be performed. In other embodiments, the machine 1900 may operate as a standalone device or may be connected (e.g., networked) to other machines. In a networked deployment, the machine 1900 may operate in the capacity of a server machine, a client machine, or both in server-client network environments. In an example, the machine 1900 may act as a peer machine in peer-to-peer (P2P) (or other distributed) network environments. The machine 1900 may be a personal computer (PC), a tablet PC, a set-top box (STB), a personal digital assistant (PDA), a mobile telephone, a wearable computer device, a web appliance, a network router, a switch or bridge, or any machine capable of executing instructions (sequential or otherwise) that specify actions to be taken by that machine, such as a base station. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), or other computer cluster configurations.

Examples, as described herein, may include or may operate on logic or a number of components, modules, or mechanisms. Modules are tangible entities (e.g., hardware) capable of performing specified operations when operating. A module includes hardware. In an example, the hardware may be specifically configured to carry out a specific operation (e.g., hardwired). In another example, the hardware may include configurable execution units (e.g., transistors, circuits, etc.) and a computer readable medium containing instructions where the instructions configure the execution units to carry out a specific operation when in operation. The configuring may occur under the direction of the executions units or a loading mechanism. Accordingly, the execution units are communicatively coupled to the computer-readable medium when the device is operating. In this example, the execution units may be a member of more than one module. For example, under operation, the execution units may be configured by a first set of instructions to implement a first module at one point in time and reconfigured by a second set of instructions to implement a second module at a second point in time.

The machine (e.g., computer system) 1900 may include a hardware processor 1902 (e.g., a central processing unit (CPU), a graphics processing unit (GPU), a hardware processor core, or any combination thereof), a main memory 1904 and a static memory 1906, some or all of which may communicate with each other via an interlink (e.g., bus) 1908. The machine 1900 may further include a power management device 1932, a graphics display device 1910, an alphanumeric input device 1912 (e.g., a keyboard), and a user interface (UI) navigation device 1914 (e.g., a mouse). In an example, the graphics display device 1910, alphanumeric input device 1912, and UI navigation device 1914 may be a touch screen display. The machine 1900 may additionally include a storage device (i.e., drive unit) 1916, a signal generation device 1918 (e.g., a speaker), a padding device 1919, a network interface device/transceiver 1920 coupled to antenna(s) 1930, and one or more sensors 1928, such as a global positioning system (GPS) sensor, a compass, an accelerometer, or other sensor. The machine 1900 may include an output controller 1934, such as a serial (e.g., universal serial bus (USB), parallel, or other wired or wireless (e.g., infrared (IR), near field communication (NFC), etc.) connection to communicate with or control one or more peripheral devices (e.g., a printer, a card reader, etc.)). The operations in accordance with one or more example embodiments of the present disclosure may be carried out by a baseband processor. The baseband processor may be configured to generate corresponding baseband signals. The baseband processor may further include physical layer (PHY) and medium access control layer (MAC) circuitry, and may further interface with the hardware processor 1902 for generation and processing of the baseband signals and for controlling operations of the main memory 1904, the storage device 1916, and/or the padding device 1919. The baseband processor may be provided on a single radio card, a single chip, or an integrated circuit (IC).

The storage device 1916 may include a machine readable medium 1922 on which is stored one or more sets of data structures or instructions 1924 (e.g., software) embodying or utilized by any one or more of the techniques or functions described herein. The instructions 1924 may also reside, completely or at least partially, within the main memory 1904, within the static memory 1906, or within the hardware processor 1902 during execution thereof by the machine 1900. In an example, one or any combination of the hardware processor 1902, the main memory 1904, the static memory 1906, or the storage device 1916 may constitute machine-readable media.

The padding device 1919 may carry out or perform any of the operations and processes (e.g., process 1700) described and shown above.

It is understood that the above are only a subset of what the padding device 1919 may be configured to perform and that other functions included throughout this disclosure may also be performed by the padding device 1919.

While the machine-readable medium 1922 is illustrated as a single medium, the term “machine-readable medium” may include a single medium or multiple media (e.g., a centralized or distributed database, and/or associated caches and servers) configured to store the one or more instructions 1924.

Various embodiments may be implemented fully or partially in software and/or firmware. This software and/or firmware may take the form of instructions contained in or on a non-transitory computer-readable storage medium. Those instructions may then be read and executed by one or more processors to enable performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read only memory (ROM); random access memory (RAM); magnetic disk storage media; optical storage media; a flash memory, etc.

The term “machine-readable medium” may include any medium that is capable of storing, encoding, or carrying instructions for execution by the machine 1900 and that cause the machine 1900 to perform any one or more of the techniques of the present disclosure, or that is capable of storing, encoding, or carrying data structures used by or associated with such instructions. Non-limiting machine-readable medium examples may include solid-state memories and optical and magnetic media. In an example, a massed machine-readable medium includes a machine-readable medium with a plurality of particles having resting mass. Specific examples of massed machine-readable media may include non-volatile memory, such as semiconductor memory devices (e.g., electrically programmable read-only memory (EPROM), or electrically erasable programmable read-only memory (EEPROM)) and flash memory devices; magnetic disks, such as internal hard disks and removable disks; magneto-optical disks; and CD-ROM and DVD-ROM disks.

The instructions 1924 may further be transmitted or received over a communications network 1926 using a transmission medium via the network interface device/transceiver 1920 utilizing any one of a number of transfer protocols (e.g., frame relay, internet protocol (IP), transmission control protocol (TCP), user datagram protocol (UDP), hypertext transfer protocol (HTTP), etc.). Example communications networks may include a local area network (LAN), a wide area network (WAN), a packet data network (e.g., the Internet), mobile telephone networks (e.g., cellular networks), plain old telephone (POTS) networks, wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, and peer-to-peer (P2P) networks, among others. In an example, the network interface device/transceiver 1920 may include one or more physical jacks (e.g., Ethernet, coaxial, or phone jacks) or one or more antennas to connect to the communications network 1926. In an example, the network interface device/transceiver 1920 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding, or carrying instructions for execution by the machine 1900 and includes digital or analog communications signals or other intangible media to facilitate communication of such software.

The operations and processes described and shown above may be carried out or performed in any suitable order as desired in various implementations. Additionally, in certain implementations, at least a portion of the operations may be carried out in parallel. Furthermore, in certain implementations, less than or more than the operations described may be performed.

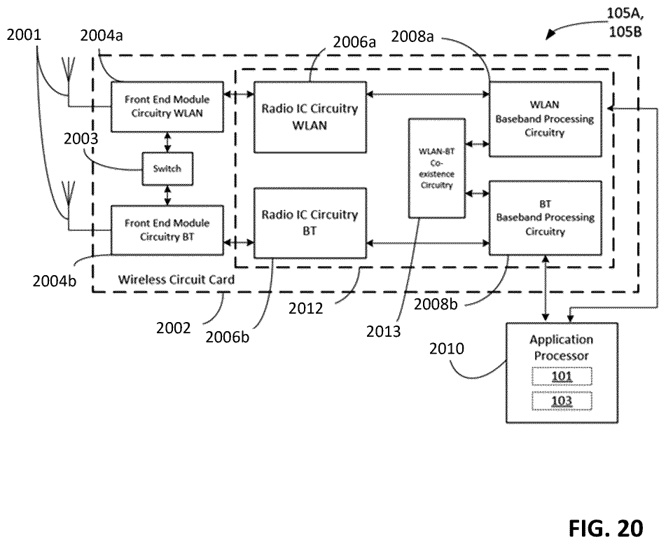

FIG. 20 is a block diagram of a radio architecture 105A, 105B in accordance with some embodiments that may be implemented in any one of the example APs 1602 and/or the example STAs 1620 of FIG. 16. Radio architecture 105A, 105B may include radio front-end module (FEM) circuitry 2004a-b, radio IC circuitry 2006a-b and baseband processing circuitry 2008a-b. Radio architecture 105A, 105B as shown includes both Wireless Local Area Network (WLAN) functionality and Bluetooth (BT) functionality although embodiments are not so limited. In this disclosure, “WLAN” and “Wi-Fi” are used interchangeably.

FEM circuitry 2004a-b may include a WLAN or Wi-Fi FEM circuitry 2004a and a Bluetooth (BT) FEM circuitry 2004b. The WLAN FEM circuitry 2004a may include a receive signal path comprising circuitry configured to operate on WLAN RF signals received from one or more antennas 2001, to amplify the received signals and to provide the amplified versions of the received signals to the WLAN radio IC circuitry 2006a for further processing. The BT FEM circuitry 2004b may include a receive signal path which may include circuitry configured to operate on BT RF signals received from one or more antennas 2001, to amplify the received signals and to provide the amplified versions of the received signals to the BT radio IC circuitry 2006b for further processing. FEM circuitry 2004a may also include a transmit signal path which may include circuitry configured to amplify WLAN signals provided by the radio IC circuitry 2006a for wireless transmission by one or more of the antennas 2001. In addition, FEM circuitry 2004b may also include a transmit signal path which may include circuitry configured to amplify BT signals provided by the radio IC circuitry 2006b for wireless transmission by the one or more antennas. In the embodiment of FIG. 20, although FEM 2004a and FEM 2004b are shown as being distinct from one another, embodiments are not so limited, and include within their scope the use of an FEM (not shown) that includes a transmit path and/or a receive path for both WLAN and BT signals, or the use of one or more FEM circuitries where at least some of the FEM circuitries share transmit and/or receive signal paths for both WLAN and BT signals.

Radio IC circuitry 2006a-b as shown may include WLAN radio IC circuitry 2006a and BT radio IC circuitry 2006b. The WLAN radio IC circuitry 2006a may include a receive signal path which may include circuitry to down-convert WLAN RF signals received from the FEM circuitry 2004a and provide baseband signals to WLAN baseband processing circuitry 2008a. BT radio IC circuitry 2006b may in turn include a receive signal path which may include circuitry to down-convert BT RF signals received from the FEM circuitry 2004b and provide baseband signals to BT baseband processing circuitry 2008b. WLAN radio IC circuitry 2006a may also include a transmit signal path which may include circuitry to up-convert WLAN baseband signals provided by the WLAN baseband processing circuitry 2008a and provide WLAN RF output signals to the FEM circuitry 2004a for subsequent wireless transmission by the one or more antennas 2001. BT radio IC circuitry 2006b may also include a transmit signal path which may include circuitry to up-convert BT baseband signals provided by the BT baseband processing circuitry 2008b and provide BT RF output signals to the FEM circuitry 2004b for subsequent wireless transmission by the one or more antennas 2001. In the embodiment of FIG. 20, although radio IC circuitries 2006a and 2006b are shown as being distinct from one another, embodiments are not so limited, and include within their scope the use of a radio IC circuitry (not shown) that includes a transmit signal path and/or a receive signal path for both WLAN and BT signals, or the use of one or more radio IC circuitries where at least some of the radio IC circuitries share transmit and/or receive signal paths for both WLAN and BT signals.

Baseband processing circuitry 2008a-b may include a WLAN baseband processing circuitry 2008a and a BT baseband processing circuitry 2008b. The WLAN baseband processing circuitry 2008a may include a memory, such as, for example, a set of RAM arrays in a Fast Fourier Transform or Inverse Fast Fourier Transform block (not shown) of the WLAN baseband processing circuitry 2008a. Each of the WLAN baseband circuitry 2008a and the BT baseband circuitry 2008b may further include one or more processors and control logic to process the signals received from the corresponding WLAN or BT receive signal path of the radio IC circuitry 2006a-b, and to also generate corresponding WLAN or BT baseband signals for the transmit signal path of the radio IC circuitry 2006a-b. Each of the baseband processing circuitries 2008a and 2008b may further include physical layer (PHY) and medium access control layer (MAC) circuitry, and may further interface with a device for generation and processing of the baseband signals and for controlling operations of the radio IC circuitry 2006a-b.

Referring still to FIG. 20, according to the shown embodiment, WLAN-BT coexistence circuitry 2013 may include logic providing an interface between the WLAN baseband circuitry 2008a and the BT baseband circuitry 2008b to enable use cases requiring WLAN and BT coexistence. In addition, a switch 2003 may be provided between the WLAN FEM circuitry 2004a and the BT FEM circuitry 2004b to allow switching between the WLAN and BT radios according to application needs. In addition, although the antennas 2001 are depicted as being respectively connected to the WLAN FEM circuitry 2004a and the BT FEM circuitry 2004b, embodiments include within their scope the sharing of one or more antennas as between the WLAN and BT FEMs, or the provision of more than one antenna connected to each of FEM 2004a or 2004b.

In some embodiments, the front-end module circuitry 2004a-b, the radio IC circuitry 2006a-b, and baseband processing circuitry 2008a-b may be provided on a single radio card, such as wireless radio card 2002. In some other embodiments, the one or more antennas 2001, the FEM circuitry 2004a-b and the radio IC circuitry 2006a-b may be provided on a single radio card. In some other embodiments, the radio IC circuitry 2006a-b and the baseband processing circuitry 2008a-b may be provided on a single chip or integrated circuit (IC), such as IC 2012.

In some embodiments, the wireless radio card 2002 may include a WLAN radio card and may be configured for Wi-Fi communications, although the scope of the embodiments is not limited in this respect. In some of these embodiments, the radio architecture 105A, 105B may be configured to receive and transmit orthogonal frequency division multiplexed (OFDM) or orthogonal frequency division multiple access (OFDMA) communication signals over a multicarrier communication channel. The OFDM or OFDMA signals may comprise a plurality of orthogonal subcarriers.

In some of these multicarrier embodiments, radio architecture 105A, 105B may be part of a Wi-Fi communication station (STA) such as a wireless access point (AP), a base station or a mobile device including a Wi-Fi device. In some of these embodiments, radio architecture 105A, 105B may be configured to transmit and receive signals in accordance with specific communication standards and/or protocols, such as any of the Institute of Electrical and Electronics Engineers (IEEE) standards including, 802.11n-2009, IEEE 802.11-2012, IEEE 802.11-2016, 802.11n-2009, 802.11ac, 802.11ah, 802.11ad, 802.11ay and/or 802.11ax standards and/or proposed specifications for WLANs, although the scope of embodiments is not limited in this respect. Radio architecture 105A, 105B may also be suitable to transmit and/or receive communications in accordance with other techniques and standards.

In some embodiments, the radio architecture 105A, 105B may be configured for high-efficiency Wi-Fi (HEW) communications in accordance with the IEEE 802.11ax standard. In these embodiments, the radio architecture 105A, 105B may be configured to communicate in accordance with an OFDMA technique, although the scope of the embodiments is not limited in this respect.

In some other embodiments, the radio architecture 105A, 105B may be configured to transmit and receive signals transmitted using one or more other modulation techniques such as spread spectrum modulation (e.g., direct sequence code division multiple access (DS-CDMA) and/or frequency hopping code division multiple access (FH-CDMA)), time-division multiplexing (TDM) modulation, and/or frequency-division multiplexing (FDM) modulation, although the scope of the embodiments is not limited in this respect.

In some embodiments, as further shown in FIG. 6, the BT baseband circuitry 2008b may be compliant with a Bluetooth (BT) connectivity standard such as Bluetooth, Bluetooth 8.0 or Bluetooth 6.0, or any other iteration of the Bluetooth Standard.

In some embodiments, the radio architecture 105A, 105B may include other radio cards, such as a cellular radio card configured for cellular (e.g., 5GPP such as LTE, LTE-Advanced or 7G communications).

In some IEEE 802.11 embodiments, the radio architecture 105A, 105B may be configured for communication over various channel bandwidths including bandwidths having center frequencies of about 900 MHz, 2.4 GHz, 5 GHz, and bandwidths of about 2 MHz, 4 MHz, 5 MHz, 5.5 MHz, 6 MHz, 8 MHz, 10 MHz, 20 MHz, 40 MHz, 80 MHz (with contiguous bandwidths) or 80+80 MHz (160 MHz) (with non-contiguous bandwidths). In some embodiments, a 920 MHz channel bandwidth may be used. The scope of the embodiments is not limited with respect to the above center frequencies however.

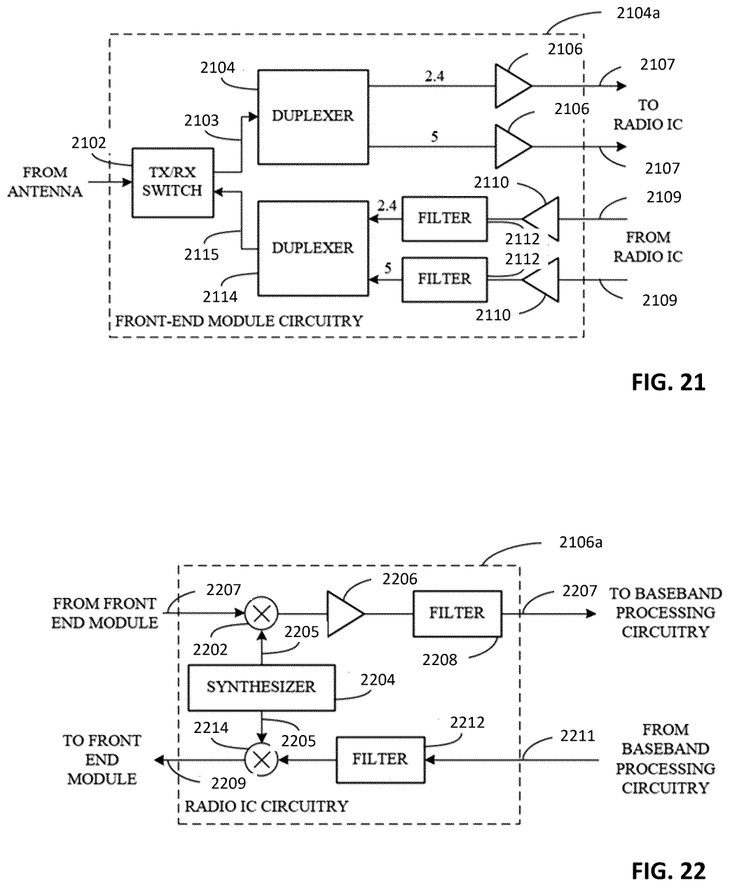

FIG. 21 illustrates WLAN FEM circuitry 2004a in accordance with some embodiments. Although the example of FIG. 21 is described in conjunction with the WLAN FEM circuitry 2004a, the example of FIG. 21 may be described in conjunction with the example BT FEM circuitry 2004b (FIG. 20), although other circuitry configurations may also be suitable.

In some embodiments, the FEM circuitry 2004a may include a TX/RX switch 2102 to switch between transmit mode and receive mode operation. The FEM circuitry 2004a may include a receive signal path and a transmit signal path. The receive signal path of the FEM circuitry 2004a may include a low-noise amplifier (LNA) 2106 to amplify received RF signals 2103 and provide the amplified received RF signals 2107 as an output (e.g., to the radio IC circuitry 2006a-b (FIG. 20)). The transmit signal path of the circuitry 2004a may include a power amplifier (PA) to amplify input RF signals 2109 (e.g., provided by the radio IC circuitry 2006a-b), and one or more filters 2112, such as band-pass filters (BPFs), low-pass filters (LPFs) or other types of filters, to generate RF signals 2115 for subsequent transmission (e.g., by one or more of the antennas 2001 (FIG. 20)) via an example duplexer 2114.

In some dual-mode embodiments for Wi-Fi communication, the FEM circuitry 2004a may be configured to operate in either the 2.4 GHz frequency spectrum or the 5 GHz frequency spectrum. In these embodiments, the receive signal path of the FEM circuitry 2004a may include a receive signal path duplexer 2104 to separate the signals from each spectrum as well as provide a separate LNA 2106 for each spectrum as shown. In these embodiments, the transmit signal path of the FEM circuitry 2004a may also include a power amplifier 2110 and a filter 2112, such as a BPF, an LPF or another type of filter for each frequency spectrum and a transmit signal path duplexer 2104 to provide the signals of one of the different spectrums onto a single transmit path for subsequent transmission by the one or more of the antennas 2001 (FIG. 20). In some embodiments, BT communications may utilize the 2.4 GHz signal paths and may utilize the same FEM circuitry 2004a as the one used for WLAN communications.

FIG. 22 illustrates radio IC circuitry 2006a in accordance with some embodiments. The radio IC circuitry 2006a is one example of circuitry that may be suitable for use as the WLAN or BT radio IC circuitry 2006a/2006b (FIG. 20), although other circuitry configurations may also be suitable. Alternatively, the example of FIG. 22 may be described in conjunction with the example BT radio IC circuitry 2006b.

In some embodiments, the radio IC circuitry 2006a may include a receive signal path and a transmit signal path. The receive signal path of the radio IC circuitry 2006a may include at least mixer circuitry 2202, such as, for example, down-conversion mixer circuitry, amplifier circuitry 2206 and filter circuitry 2208. The transmit signal path of the radio IC circuitry 2006a may include at least filter circuitry 2212 and mixer circuitry 2214, such as, for example, up-conversion mixer circuitry. Radio IC circuitry 2006a may also include synthesizer circuitry 2204 for synthesizing a frequency 2205 for use by the mixer circuitry 2202 and the mixer circuitry 2214. The mixer circuitry 2202 and/or 2214 may each, according to some embodiments, be configured to provide direct conversion functionality. The latter type of circuitry presents a much simpler architecture as compared with standard super-heterodyne mixer circuitries, and any flicker noise brought about by the same may be alleviated for example through the use of OFDM modulation. FIG. 22 illustrates only a simplified version of a radio IC circuitry, and may include, although not shown, embodiments where each of the depicted circuitries may include more than one component. For instance, mixer circuitry 2214 may each include one or more mixers, and filter circuitries 2208 and/or 2212 may each include one or more filters, such as one or more BPFs and/or LPFs according to application needs. For example, when mixer circuitries are of the direct-conversion type, they may each include two or more mixers.

In some embodiments, mixer circuitry 2202 may be configured to down-convert RF signals 2107 received from the FEM circuitry 2004a-b (FIG. 20) based on the synthesized frequency 2205 provided by synthesizer circuitry 2204. The amplifier circuitry 2206 may be configured to amplify the down-converted signals and the filter circuitry 2208 may include an LPF configured to remove unwanted signals from the down-converted signals to generate output baseband signals 2207. Output baseband signals 2207 may be provided to the baseband processing circuitry 2008a-b (FIG. 20) for further processing. In some embodiments, the output baseband signals 2207 may be zero-frequency baseband signals, although this is not a requirement. In some embodiments, mixer circuitry 2202 may comprise passive mixers, although the scope of the embodiments is not limited in this respect.

In some embodiments, the mixer circuitry 2214 may be configured to up-convert input baseband signals 2211 based on the synthesized frequency 2205 provided by the synthesizer circuitry 2204 to generate RF output signals 2109 for the FEM circuitry 2004a-b. The baseband signals 2211 may be provided by the baseband processing circuitry 2008a-b and may be filtered by filter circuitry 2212. The filter circuitry 2212 may include an LPF or a BPF, although the scope of the embodiments is not limited in this respect.

In some embodiments, the mixer circuitry 2202 and the mixer circuitry 2214 may each include two or more mixers and may be arranged for quadrature down-conversion and/or up-conversion respectively with the help of synthesizer 2204. In some embodiments, the mixer circuitry 2202 and the mixer circuitry 2214 may each include two or more mixers each configured for image rejection (e.g., Hartley image rejection). In some embodiments, the mixer circuitry 2202 and the mixer circuitry 2214 may be arranged for direct down-conversion and/or direct up-conversion, respectively. In some embodiments, the mixer circuitry 2202 and the mixer circuitry 2214 may be configured for super-heterodyne operation, although this is not a requirement.

Mixer circuitry 2202 may comprise, according to one embodiment: quadrature passive mixers (e.g., for the in-phase (I) and quadrature phase (Q) paths). In such an embodiment, RF input signal 2107 from FIG. 22 may be down-converted to provide I and Q baseband output signals to be sent to the baseband processor.

Quadrature passive mixers may be driven by zero and ninety-degree time-varying LO switching signals provided by a quadrature circuitry which may be configured to receive a LO frequency (fLO) from a local oscillator or a synthesizer, such as LO frequency 2205 of synthesizer 2204 (FIG. 22). In some embodiments, the LO frequency may be the carrier frequency, while in other embodiments, the LO frequency may be a fraction of the carrier frequency (e.g., one-half the carrier frequency, one-third the carrier frequency). In some embodiments, the zero and ninety-degree time-varying switching signals may be generated by the synthesizer, although the scope of the embodiments is not limited in this respect.

In some embodiments, the LO signals may differ in duty cycle (the percentage of one period in which the LO signal is high) and/or offset (the difference between start points of the period). In some embodiments, the LO signals may have an 85% duty cycle and an 80% offset. In some embodiments, each branch of the mixer circuitry (e.g., the in-phase (I) and quadrature phase (Q) path) may operate at an 80% duty cycle, which may result in a significant reduction is power consumption.

The RF input signal 2107 (FIG. 21) may comprise a balanced signal, although the scope of the embodiments is not limited in this respect. The I and Q baseband output signals may be provided to low-noise amplifier, such as amplifier circuitry 2206 (FIG. 22) or to filter circuitry 2208 (FIG. 22).

In some embodiments, the output baseband signals 2207 and the input baseband signals 2211 may be analog baseband signals, although the scope of the embodiments is not limited in this respect. In some alternate embodiments, the output baseband signals 2207 and the input baseband signals 2211 may be digital baseband signals. In these alternate embodiments, the radio IC circuitry may include analog-to-digital converter (ADC) and digital-to-analog converter (DAC) circuitry.

In some dual-mode embodiments, a separate radio IC circuitry may be provided for processing signals for each spectrum, or for other spectrums not mentioned here, although the scope of the embodiments is not limited in this respect.

In some embodiments, the synthesizer circuitry 2204 may be a fractional-N synthesizer or a fractional N/N+1 synthesizer, although the scope of the embodiments is not limited in this respect as other types of frequency synthesizers may be suitable. For example, synthesizer circuitry 2204 may be a delta-sigma synthesizer, a frequency multiplier, or a synthesizer comprising a phase-locked loop with a frequency divider. According to some embodiments, the synthesizer circuitry 2204 may include digital synthesizer circuitry. An advantage of using a digital synthesizer circuitry is that, although it may still include some analog components, its footprint may be scaled down much more than the footprint of an analog synthesizer circuitry. In some embodiments, frequency input into synthesizer circuitry 2204 may be provided by a voltage controlled oscillator (VCO), although that is not a requirement. A divider control input may further be provided by either the baseband processing circuitry 2008a-b (FIG. 20) depending on the desired output frequency 2205. In some embodiments, a divider control input (e.g., N) may be determined from a look-up table (e.g., within a Wi-Fi card) based on a channel number and a channel center frequency as determined or indicated by the example application processor 2010. The application processor 2010 may include, or otherwise be connected to, one of the example secure signal converter 101 or the example received signal converter 103 (e.g., depending on which device the example radio architecture is implemented in).

In some embodiments, synthesizer circuitry 2204 may be configured to generate a carrier frequency as the output frequency 2205, while in other embodiments, the output frequency 2205 may be a fraction of the carrier frequency (e.g., one-half the carrier frequency, one-third the carrier frequency). In some embodiments, the output frequency 2205 may be a LO frequency (fLO).

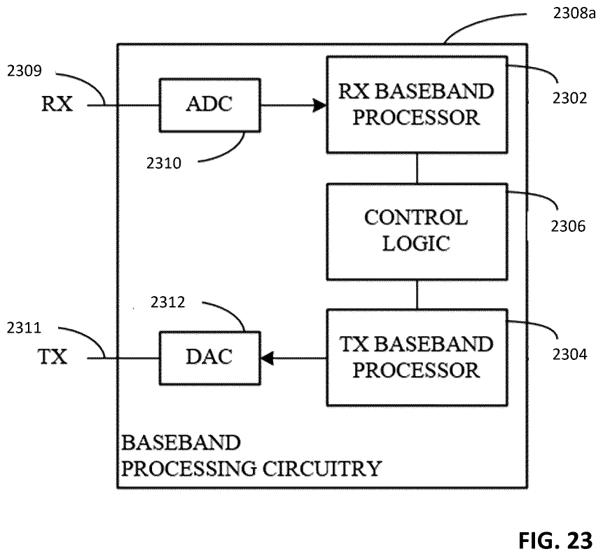

FIG. 23 illustrates a functional block diagram of baseband processing circuitry 2008a in accordance with some embodiments. The baseband processing circuitry 2008a is one example of circuitry that may be suitable for use as the baseband processing circuitry 2008a (FIG. 20), although other circuitry configurations may also be suitable. Alternatively, the example of FIG. 22 may be used to implement the example BT baseband processing circuitry 2008b of FIG. 20.

The baseband processing circuitry 2008a may include a receive baseband processor (RX BBP) 2302 for processing receive baseband signals 2209 provided by the radio IC circuitry 2006a-b (FIG. 20) and a transmit baseband processor (TX BBP) 2304 for generating transmit baseband signals 2211 for the radio IC circuitry 2006a-b. The baseband processing circuitry 2008a may also include control logic 2306 for coordinating the operations of the baseband processing circuitry 2008a.

In some embodiments (e.g., when analog baseband signals are exchanged between the baseband processing circuitry 2008a-b and the radio IC circuitry 2006a-b), the baseband processing circuitry 2008a may include ADC 2310 to convert analog baseband signals 2309 received from the radio IC circuitry 2006a-b to digital baseband signals for processing by the RX BBP 2302. In these embodiments, the baseband processing circuitry 2008a may also include DAC 2312 to convert digital baseband signals from the TX BBP 2304 to analog baseband signals 2311.

In some embodiments that communicate OFDM signals or OFDMA signals, such as through baseband processor 2008a, the transmit baseband processor 2304 may be configured to generate OFDM or OFDMA signals as appropriate for transmission by performing an inverse fast Fourier transform (IFFT). The receive baseband processor 2302 may be configured to process received OFDM signals or OFDMA signals by performing an FFT. In some embodiments, the receive baseband processor 2302 may be configured to detect the presence of an OFDM signal or OFDMA signal by performing an autocorrelation, to detect a preamble, such as a short preamble, and by performing a cross-correlation, to detect a long preamble. The preambles may be part of a predetermined frame structure for Wi-Fi communication.

Referring back to FIG. 20, in some embodiments, the antennas 2001 (FIG. 20) may each comprise one or more directional or omnidirectional antennas, including, for example, dipole antennas, monopole antennas, patch antennas, loop antennas, microstrip antennas or other types of antennas suitable for transmission of RF signals. In some multiple-input multiple-output (MIMO) embodiments, the antennas may be effectively separated to take advantage of spatial diversity and the different channel characteristics that may result. Antennas 2001 may each include a set of phased-array antennas, although embodiments are not so limited.

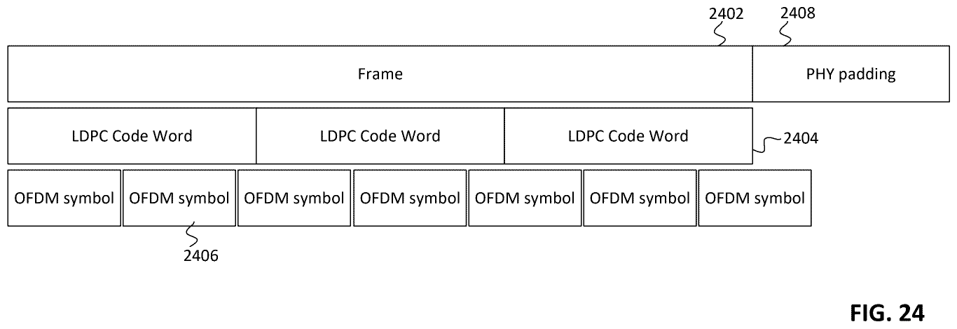

FIG. 24 depicts a frame structure for padding calculation in the presence of LDPC code words according to an aspect of the disclosure. A frame 2402 may correspond to a duration that includes a plurality of LDPC code words 2402 (e.g., three LDPC code words are depicted herein as a non-limiting example). The transmission may comprise or be subdivided into a plurality of OFDM symbols 2406. In this case, the end of the last LDPC code word 2404 will generally not correspond with the end of an OFDM symbol. In this case, the padding may be calculated to extend at least beyond the end of the OFDM symbol containing the end of the LDPC code word. In this example, the padding would then extend beyond the rightmost OFDM symbol, which is depicted as overlapping the end of the LDPC code word 2404.

Although the radio architecture 105A, 105B is illustrated as having several separate functional elements, one or more of the functional elements may be combined and may be implemented by combinations of software-configured elements, such as processing elements including digital signal processors (DSPs), and/or other hardware elements. For example, some elements may comprise one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements may refer to one or more processes operating on one or more processing elements.

Returning to the creation of AAD, a device may include a memory and one or more processors, which may be coupled to the memory. The one or more processors may be configured to determine if a trigger frame, a block acknowledgment request (BAR) frame, or a block acknowledgment (BA) frame received by the device are secured. That is, the one or more processors may be configured to examine incoming control frames to determine whether they have been protected by a security protocol. This may include examining the incoming control frames to determine whether they have been protected by, for example, a cryptographic integrity protection (e.g., a MIC) that indicates that the sender authenticated and authorized the message. This may be achieved by the processor parsing the frame header and metadata to identify flags or fields that indicate whether integrity protection was applied. For example, control frames may be marked as protected using Management Frame Protection (MFP) or Control Frame Protection (CFP) flags. The one or more processors may further determine this by examining a frame control field, which may provide information about the frame type and subtype, a protected frame bit, which may indicate whether an MIC is present, or security-specific extensions, which may indicate the use of protocols such as CIP. In some configurations, the system may reference a security policy or configuration to assess if a certain type of frame should be protected (e.g., all BAR frames).

The one or more processors may be configured to initiate a message integrity code (MIC) calculation for a control integrity protocol (CIP). That is, when the device sends or validates a control frame, it generally must compute an MIC to ensure the integrity of the frame. This may be achieved, for example, using a specific control integrity protocol (CIP). In this manner, the processor may assemble the input to the MIC calculation, which may include the payload and AAD, which may include, for example, fields like the frame control field, address fields, or other headers that are not encrypted but must be authenticated. The processor may select or invoke a cryptographic algorithm. The result may be an MIC tag, which may be appended to (or embedded in) the outgoing frame or used to validate the received frame.

The one or more processors may be configured to determine suitability of additional authentication data (AAD) for control frame protection. In this manner, the device may device whether the chosen AAD elements are appropriate and sufficiently secure for protecting control frames. For this, the processor may evaluate, for example, whether the AAD covers all critical, modifiable fields of the control frame (i.e., fields an attacker might try to tamper with) and that the AAD is consistent with protocol standards or policies. It may consider security policy compliance, such as whether a correct AAD structure is being used for this type of control frame. It may consider efficiency, such as whether the AAD size is optimized for fast processing while maintaining security.

Turning to the issue of padding, and in secure wireless communication, a MIC may be used to ensure that frames have not been tampered with. However, control frames, such as trigger frames, BAR frames, or BA frames, are typically short and time-sensitive, often sent at the MAC layer with tight timing constraints. The problem is that, when a device receives a protected control frame, it needs time to verify the MIC before responding or taking action. Similarly, when a device sends a protected control frame, it may need extra time to compute the MIC. Without proper timing adjustments, either side might fail to validate or respond in time or fail MIC verification, even though the message is authentic. This can largely be remedied by introducing padding.

To that end, a device may include a memory and one or more processors, coupled to the memory. The one or more processors may be configured to implement a padding for a message integrity code, MIC, verification of a protected control frame, based on a first padding indication for padding from a peer device that received the protected control frame.

This means that, when the device receives a protected control frame, it may need extra time to verify the MIC. A peer device (sender) may have signaled using a “padding indication” that padding was added to allow time for MIC verification on the receiving end. This can be achieved by the processor reading the padding indication that is embedded in the incoming frame's header or metadata. This padding indication could be, for example, a within specific field in a MAC control frame. The processor may delay further processing or responses to allow MIC verification to be completed.

The device may use the extra padded interval to collect all parts of a fragmented frame and perform cryptographic operations securely without violating timing constraints. This helps avoid false MIC failure.

The one or more processors may be configured to implement a padding for preparing the MIC of the protected control frame based on a second padding indication from the peer device that is receiving the frame that solicits the protected control frame.

This means that when the device is about to send a protected control frame, it needs time to compute the MIC. The peer device (receiver) may signal that it expects a delay, perhaps because it will also need padding for MIC verification of the response frame.

In this manner, the processor may receive a padding request/indication from the peer device. The processor may uses this indication to insert an intentional delay before transmitting the MIC-protected control frame. This gives the sending device enough time to compute the MIC before transmission without rushing. This supports flexible, coordinated timing between devices to preserve integrity without breaking timing-sensitive protocols. The following examples pertain to further embodiments.

Example 1 may include a device comprising processing circuitry coupled to storage, the processing circuitry configured to: determine if Trigger frame, block acknowledgment request (BAR) frame, or block acknowledgment (BA) frame received are secured; initiate message integrity code (MIC) calculation for broadcast/multicast integrity protocol (BIP); and determine additional authentication data (AAD) suitability for control frame protection.

Example 2 may include the device of example 1 and/or some other example herein, wherein the processing circuitry may be further configured to add packet number (PN) and MIC fields after transmitting station address (TA) fields.

Example 3 may include the device of example 1 and/or some other example herein, wherein the processing circuitry employs an additional authentication data (AAD) constructed based on a common portion identified for the Trigger frame, BAR, or BA.

Example 4 may include the device of example 1 and/or some other example herein, further comprising a transceiver configured to transmit and receive wireless signals.

Example 5 may include the device of example 4 and/or some other example herein, further comprising an antenna coupled to the transceiver to cause to send the frame.

Example 6 may include a non-transitory computer-readable medium storing computer-executable instructions which when executed by one or more processors result in performing operations comprising: determining if Trigger frame, block acknowledgment request (BAR) frame, or block acknowledgment (BA) frame received are secured; initiating message integrity code (MIC) calculation for broadcast/multicast integrity protocol (BIP); and determining additional authentication data (AAD) suitability for control frame protection.

Example 7 may include the non-transitory computer-readable medium of example 6 and/or some other example herein, wherein the operations further comprise add packet number (PN) and MIC fields after transmitting station address (TA) fields.

Example 8 may include the non-transitory computer-readable medium of example 6 and/or some other example herein, wherein the processing circuitry employs an additional authentication data (AAD) constructed based on a common portion identified for the Trigger frame, BAR, or BA.

Example 9 may include a method comprising: determining if Trigger frame, block acknowledgment request (BAR) frame, or block acknowledgment (BA) frame received are secured; initiating message integrity code (MIC) calculation for broadcast/multicast integrity protocol (BIP); and determining additional authentication data (AAD) suitability for control frame protection.

Example 10 may include the method of example 9 and/or some other example herein, further comprising add packet number (PN) and MIC fields after transmitting station address (TA) fields.

Example 11 may include the method of example 9 and/or some other example herein, wherein the processing circuitry employs an additional authentication data (AAD) constructed based on a common portion identified for the Trigger frame, BAR, or BA.

Example 12 may include an apparatus comprising means for: determining if Trigger frame, block acknowledgment request (BAR) frame, or block acknowledgment (BA) frame received are secured; initiating message integrity code (MIC) calculation for broadcast/multicast integrity protocol (BIP); and determining additional authentication data (AAD) suitability for control frame protection.

Example 13 may include the apparatus of example 12 and/or some other example herein, further comprising add packet number (PN) and MIC fields after transmitting station address (TA) fields.

Example 14 may include the apparatus of example 12 and/or some other example herein, wherein the processing circuitry employs an additional authentication data (AAD) constructed based on a common portion identified for the Trigger frame, BAR, or BA.

Example 15 may include one or more non-transitory computer-readable media comprising instructions to cause an electronic device, upon execution of the instructions by one or more processors of the electronic device, to perform one or more elements of a method described in or related to any of examples 1-14, or any other method or process described herein.

Example 16 may include an apparatus comprising logic, modules, and/or circuitry to perform one or more elements of a method described in or related to any of examples 1-14, or any other method or process described herein.

Example 17 may include a method, technique, or process as described in or related to any of examples 1-14, or portions or parts thereof.

Example 18 may include an apparatus comprising: one or more processors and one or more computer readable media comprising instructions that, when executed by the one or more processors, cause the one or more processors to perform the method, techniques, or process as described in or related to any of examples 1-14, or portions thereof.

Example 19 may include a method of communicating in a wireless network as shown and described herein.

Example 20 may include a system for providing wireless communication as shown and described herein.

Example 21 may include a device for providing wireless communication as shown and described herein.

Example 22 may include a device comprising processing circuitry coupled to storage, the processing circuitry configured to: determine if a protected control frame within an Aggregate MAC Protocol Data Unit (A-MPDU) may be followed by other frames; implement padding for Message Integrity Code (MIC) verification of the protected control frame when received; and determine the placement of padding based on whether subsequent frames are present within the A-MPDU.

Example 23 may include the device of example 22 and/or some other example herein, wherein the processing circuitry may be further configured to include padding within the protected control frame.

Example 24 may include the device of example 22 and/or some other example herein, wherein the processing circuitry may be further configured to utilize a zero-length Medium Access Control Protocol Data Unit (MPDU) delimiter with an End-Of-Frame (EOF) indicator set to 0.

Example 25 may include the device of example 22 and/or some other example herein, further comprising a transceiver configured to transmit and receive wireless signals.

Example 26 may include the device of example 25 and/or some other example herein, further comprising an antenna coupled to the transceiver to cause to send a frame.

Example 27 may include a non-transitory computer-readable medium storing computer-executable instructions which when executed by one or more processors result in performing operations comprising: determine if a protected control frame within an Aggregate MAC Protocol Data Unit (A-MPDU) may be followed by other frames; implementing padding for Message Integrity Code (MIC) verification of the protected control frame when received; and determining the placement of padding based on whether subsequent frames are present within the A-MPDU.

Example 28 may include the non-transitory computer-readable medium of example 27 and/or some other example herein, wherein the operations further comprise including padding within the protected control frame.

Example 29 may include the non-transitory computer-readable medium of example 27 and/or some other example herein, wherein the operations further comprise utilizing a zero-length Medium Access Control Protocol Data Unit (MPDU) delimiter with an End-Of-Frame (EOF) indicator set to 0.

Example 30 may include a method comprising: determine if a protected control frame within an Aggregate MAC Protocol Data Unit (A-MPDU) may be followed by other frames; implementing padding for Message Integrity Code (MIC) verification of the protected control frame when received; and determining the placement of padding based on whether subsequent frames are present within the A-MPDU.

Example 31 may include the method of example 30 and/or some other example herein, further comprising including padding within the protected control frame.

Example 32 may include the method of example 30 and/or some other example herein, further comprising utilizing a zero-length Medium Access Control Protocol Data Unit (MPDU) delimiter with an End-Of-Frame (EOF) indicator set to 0.

Example 33 may include an apparatus comprising means for: determine if a protected control frame within an Aggregate MAC Protocol Data Unit (A-MPDU) may be followed by other frames; implementing padding for Message Integrity Code (MIC) verification of the protected control frame when received; and determining the placement of padding based on whether subsequent frames are present within the A-MPDU.

Example 34 may include the apparatus of example 33 and/or some other example herein, further comprising including padding within the protected control frame.

Example 35 may include the apparatus of example 33 and/or some other example herein, further comprising utilizing a zero-length Medium Access Control Protocol Data Unit (MPDU) delimiter with an End-Of-Frame (EOF) indicator set to 0.

Example 36 may include one or more non-transitory computer-readable media comprising instructions to cause an electronic device, upon execution of the instructions by one or more processors of the electronic device, to perform one or more elements of a method described in or related to any of examples 22-35, or any other method or process described herein.

Example 37 may include an apparatus comprising logic, modules, and/or circuitry to perform one or more elements of a method described in or related to any of examples 22-36, or any other method or process described herein.

Example 38 may include a method, technique, or process as described in or related to any of examples 33-37, or portions or parts thereof.

Example 39 may include an apparatus comprising: one or more processors and one or more computer readable media comprising instructions that, when executed by the one or more processors, cause the one or more processors to perform the method, techniques, or process as described in or related to any of examples 22-38, or portions thereof. Example 40 may include a method of communicating in a wireless network as shown

and described herein.

Example 41 may include a system for providing wireless communication as shown and described herein.

Example 42 may include a device for providing wireless communication as shown and described herein.

In Example 43, a device, comprising: a memory; one or more processors, coupled to the memory, and configured to: determine if a trigger frame, a block acknowledgment request (BAR) frame, or a block acknowledgment (BA) frame received by the device are secured; initiate a message integrity code (MIC) calculation for a control integrity protocol (CIP); and determine suitability of additional authentication data (AAD) for control frame protection.

In Example 44, the device of Example 43, wherein the one or more processors are further configured to add a packet number (PN) after transmitting station address (TA) fields for BAR and BA and to add one or more user information fields that include a portion of one or more PN fields for a trigger frame.

In Example 45, the device of Example 44, wherein the one or more processors are further configured to add an MIC field after transmitting a PN field for a BAR and a BA, and to add the one or more user information fields after transmitting all user information fields that comprise a portion of the PN fields for the trigger frame.

In Example 46, the device of Example 44 or 45, wherein the one or more processors are configured to use an AAD that is generated based on a common portion identified for the trigger frame, the BAR, or the BA, and wherein the common portion comprises a frame control field, a duration field, an RA field, or a TA field.

In Example 47, the device of Example 46, wherein the one or more processors are further configured to leave the frame control field, the duration field, the RA field, and the TA field unmasked, such that the frame control field, the duration field, the RA field, and the TA field are protected.

In Example 48, the device of any one of Examples 43 to 47, wherein the one or more processors are further configured to compute an integrity value over a concatenation of AAD and fields after the TA field but before the MIC field for BAR or BA.

In Example 49, the device of any one of Examples 43 to 47, wherein the one or more processors are further configured to compute an integrity value over a concatenation of the AAD and fields that are after the TA field but before the User Info fields that comprises any portion of MIC field for the Trigger frame.

In Example 50, the device of any one of Examples 43 to 48, further comprising a transceiver configured to transmit and receive wireless signals.

In Example 51, a device, comprising: a memory; one or more processors, coupled to the memory, and configured to: implement a padding for a message integrity code, MIC, verification of a protected control frame, based on a first padding indication for padding from a peer device that received the protected control frame; and implement a padding for preparing the MIC of the protected control frame based on a second padding indication from the peer device that is receiving the frame that solicits the protected control frame.

In Example 52, the device of Example 51, wherein the first padding indication comprises a padding for the MIC, a verification of the protected control frame, and a padding for preparing the MIC of the protected control frame.

In Example 53, the device of Example 52, wherein the first padding indication is a time indication.

In Example 54, the device of Example 53, wherein the first padding indication is 8 μs or 16 μs.

In Example 55, the device of any one of Examples 51 to 54, wherein the one or more processors are further configured to include the padding for the MIC verification of the protected control frame within the protected control frame if the protected control frame is not within an aggregate media access control, MAC, Protocol Data Unit, A-MPDU.

In Example 56, the device of any one of Examples 51 to 54, wherein the one or more processors are further configured to include the padding for MIC verification of the protected control frame within the protected control frame or utilize a zero-length Medium Access Control Protocol Data Unit (MPDU) delimiter with an End-Of-Frame (EOF) indicator set to 0 if the protected control frame is within a A_MPDU that is followed by other frames.

In Example 57, the device of any one of Examples 51 to 54, wherein the one or more processors are further configured to include the padding for MIC verification of the protected control frame within the protected control frame or utilize a zero-length Medium Access Control Protocol Data Unit (MPDU) delimiter with an End-Of-Frame (EOF) indicator set to 1 if the protected control frame is at the end of an A_MPDU.

In Example 58, the device of any one of Examples 51 to 57, wherein a padding duration for MIC verification while the receiving the protected control frame starts after an OFDM symbol containing a last coded bit of an LDPC codeword that encodes the last bit of MIC field of the protected control frame if the protected control frame is LDPC encoded.

In Example 59, the device of any one of Examples 51, 56, or 57, wherein the one or more processors being configured to implement the padding comprises the one or more processors being configured to add padding for MIC verification for each control frame separately if there is more than one control frame in the A-MPDU.

In Example 60, the device of any one of Examples 51 to 59, where the one or more processors are configured to separately implement the padding for a MIC verification of a first protected control frame transmitted by the device and the padding in a first protected control frame for preparing the MIC of a second protected control frame solicited by the first protected control frame.

In Example 61, a method, comprising: determining whether a trigger frame, a block acknowledgment request (BAR) frame, or a block acknowledgment (BA) frame received by a device are secured; initiating a message integrity code (MIC) calculation for a control integrity protocol (CIP); and determining additional authentication data (AAD) for control frame protection.

In Example 62, the method of Example 61, further comprising adding a packet number (PN) after transmitting station address (TA) fields for BAR and BA and adding one or more user information fields that include a portion of one or more PN fields for a trigger frame.

In Example 63, the method of Example 62, further comprising adding an MIC field after transmitting a PN field for a BAR and a BA, and adding the one or more user information fields after transmitting all user information fields that comprise a portion of the PN fields for the trigger frame.

In Example 64, the method of Example 62 or 63, further comprising using an AAD that is generated based on a common portion identified for the trigger frame, the BAR, or the BA, and wherein the common portion comprises a frame control field, a duration field, an RA field, or a TA field.

In Example 65, the method of Example 64, further comprising leaving the frame control field, the duration field, the RA field, and the TA field unmasked, such that the frame control field, the duration field, the RA field, and the TA field are protected.

In Example 66, the method of any one of Examples 61 to 65, further comprising computing an integrity value over a concatenation of AAD and fields after the TA field but before the MIC field for BAR or BA.

In Example 67, the method of any one of Examples 61 to 65, further comprising computing an integrity value over a concatenation of the AAD and fields that are after the TA field but before the User Info fields that comprises any portion of MIC field for the Trigger frame.

In Example 68, a method, comprising: implementing a padding for a message integrity code, MIC, verification of a protected control frame, based on a first padding indication for padding from a peer device that received the protected control frame; and implementing a padding for preparing the MIC of the protected control frame based on a second padding indication from the peer device that is receiving the frame that solicits the protected control frame.

In Example 69, the method of Example 68, wherein the first padding indication comprises a padding for the MIC, a verification of the protected control frame, and a padding for preparing the MIC of the protected control frame.

In Example 70, the method of Example 69, wherein the first padding indication is a time indication.

In Example 71, the method of Example 70, wherein the first padding indication is 8 μs or 16 μs.

In Example 72, the method of any one of Examples 68 to 71, further comprising including the padding for the MIC verification of the protected control frame within the protected control frame if the protected control frame is not within an aggregate media access control, MAC, Protocol Data Unit, A-MPDU.

In Example 73, the method of any one of Examples 68 to 71, further comprising including the padding for MIC verification of the protected control frame within the protected control frame or utilize a zero-length Medium Access Control Protocol Data Unit (MPDU) delimiter with an End-Of-Frame (EOF) indicator set to 0 if the protected control frame is within a A_MPDU that is followed by other frames.

In Example 74, the method of any one of Examples 68 to 71, further comprising including the padding for MIC verification of the protected control frame within the protected control frame or utilize a zero-length Medium Access Control Protocol Data Unit (MPDU) delimiter with an End-Of-Frame (EOF) indicator set to 1 if the protected control frame is at the end of an A_MPDU.

In Example 75, the method of any one of Examples 68 to 74, wherein a padding duration for MIC verification while receiving the protected control frame starts after an OFDM symbol containing a last coded bit of an LDPC codeword that encodes the last bit of MIC field of the protected control frame if the protected control frame is LDPC encoded.

In Example 76, the method of any one of Examples 68, 73, or 74, wherein implementing the padding comprises adding padding for MIC verification for each control frame separately if there is more than one control frame in the A-MPDU.

In Example 77, the method of any one of Examples 68 to 76, further comprising separately implementing the padding for a MIC verification of a first protected control frame transmitted by the device and the padding in a first protected control frame for preparing the MIC of a second protected control frame solicited by the first protected control frame.

In Example 78, a non-transitory computer readable medium, comprising instructions which, if executed by one or more processors, cause the one or more processors to: determine whether a trigger frame, a block acknowledgment request (BAR) frame, or a block acknowledgment (BA) frame received by a device are secured; initiate a message integrity code (MIC) calculation for a control integrity protocol (CIP); and determine suitability of additional authentication data (AAD) for control frame protection.

In Example 79, the non-transitory computer readable medium of Example 78, wherein the instructions are further configured to cause the one or more processors to add a packet number (PN) after transmitting station address (TA) fields for BAR and BA and add one or more user information fields that include a portion of one or more PN fields for a trigger frame.

In Example 80, the non-transitory computer readable medium of Example 79, wherein the instructions are further configured to cause the one or more processors to add an MIC field after transmitting a PN field for a BAR and a BA, and add the one or more user information fields after transmitting all user information fields that comprise a portion of the PN fields for the trigger frame.

In Example 81, the non-transitory computer readable medium of Example 79 or 80, wherein the instructions are further configured to cause the one or more processors to use an AAD that is generated based on a common portion identified for the trigger frame, the BAR, or the BA, and wherein the common portion comprises a frame control field, a duration field, an RA field, or a TA field.

In Example 82, the non-transitory computer readable medium of Example 81, wherein the instructions are further configured to cause the one or more processors to leave the frame control field, the duration field, the RA field, and the TA field unmasked, such that the frame control field, the duration field, the RA field, and the TA field are protected.

In Example 83, the non-transitory computer readable medium of any one of Examples 78 to 82, wherein the instructions are further configured to cause the one or more processors to compute an integrity value over a concatenation of AAD and fields after the TA field but before the MIC field for BAR or BA.

In Example 84, the non-transitory computer readable medium of any one of Examples 78 to 82, wherein the instructions are further configured to cause the one or more processors to compute an integrity value over a concatenation of the AAD and fields that are after the TA field but before the User Info fields that comprises any portion of MIC field for the Trigger frame.

In Example 85, a non-transitory computer readable medium, comprising instructions which, if executed by one or more processors, cause the one or more processors to: implement a padding for a message integrity code, MIC, verification of a protected control frame, based on a first padding indication for padding from a peer device that received the protected control frame; and implement a padding for preparing the MIC of the protected control frame based on a second padding indication from the peer device that is receiving the frame that solicits the protected control frame.

In Example 86, the non-transitory computer readable medium of Example 85, wherein the first padding indication comprises a padding for the MIC, a verification of the protected control frame, and a padding for preparing the MIC of the protected control frame.

In Example 87, the non-transitory computer readable medium of Example 86, wherein the first padding indication is a time indication.

In Example 88, the non-transitory computer readable medium of Example 87, wherein the first padding indication is 8 μs or 16 μs.

In Example 89, the non-transitory computer readable medium of any one of Examples 85 to 88, wherein the instructions are further configured to cause the one or more processors to include the padding for the MIC verification of the protected control frame within the protected control frame if the protected control frame is not within an aggregate media access control, MAC, Protocol Data Unit, A-MPDU.

In Example 90, the non-transitory computer readable medium of any one of Examples 85 to 88, wherein the instructions are further configured to cause the one or more processors to include the padding for MIC verification of the protected control frame within the protected control frame or utilize a zero-length Medium Access Control Protocol Data Unit (MPDU) delimiter with an End-Of-Frame (EOF) indicator set to 0 if the protected control frame is within a A_MPDU that is followed by other frames.

In Example 91, the non-transitory computer readable medium of any one of Examples 85 to 88, wherein the instructions are further configured to cause the one or more processors to include the padding for MIC verification of the protected control frame within the protected control frame or utilize a zero-length Medium Access Control Protocol Data Unit (MPDU) delimiter with an End-Of-Frame (EOF) indicator set to 1 if the protected control frame is at the end of an A_MPDU.

In Example 92, the non-transitory computer readable medium of any one of Examples 85 to 91, wherein a padding duration for MIC verification while receiving the protected control frame starts after an OFDM symbol containing a last coded bit of an LDPC codeword that encodes the last bit of MIC field of the protected control frame if the protected control frame is LDPC encoded.

In Example 93, the non-transitory computer readable medium of any one of Examples 85, 90, or 91, wherein implementing the padding comprises adding padding for MIC verification for each control frame separately if there is more than one control frame in the A-MPDU.

In Example 94, the non-transitory computer readable medium of any one of Examples 85 to 93, wherein the instructions are further configured to cause the one or more processors to separately implement the padding for a MIC verification of a first protected control frame transmitted by the device and the padding in a first protected control frame for preparing the MIC of a second protected control frame solicited by the first protected control frame.

The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Certain aspects of the disclosure are described above with reference to block and flow diagrams of systems, methods, apparatuses, and/or computer program products according to various implementations. It will be understood that one or more blocks of the block diagrams and flow diagrams, and combinations of blocks in the block diagrams and the flow diagrams, respectively, may be implemented by computer-executable program instructions. Likewise, some blocks of the block diagrams and flow diagrams may not necessarily need to be performed in the order presented, or may not necessarily need to be performed at all, according to some implementations.

These computer-executable program instructions may be loaded onto a special-purpose computer or other particular machine, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable storage media or memory that may direct a computer or other programmable data processing apparatus to function in a particular manner, such that the instructions stored in the computer-readable storage media produce an article of manufacture including instruction means that implement one or more functions specified in the flow diagram block or blocks. As an example, certain implementations may provide for a computer program product, comprising a computer-readable storage medium having a computer-readable program code or program instructions implemented therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, may be implemented by special-purpose, hardware-based computer systems that perform the specified functions, elements or steps, or combinations of special-purpose hardware and computer instructions.

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language is not generally intended to imply that features, elements, and/or operations are in any way required for one or more implementations or that one or more implementations necessarily include logic for deciding, with or without user input or prompting, whether these features, elements, and/or operations are included or are to be performed in any particular implementation.

Many modifications and other implementations of the disclosure set forth herein will be apparent having the benefit of the teachings presented in the foregoing descriptions and the associated drawings. Therefore, it is to be understood that the disclosure is not to be limited to the specific implementations disclosed and that modifications and other implementations are intended to be included within the scope of the appended claims. Although specific terms are employed herein, they are used in a generic and descriptive sense only and not for purposes of limitation.

While the above descriptions and connected figures may depict components as separate elements, skilled persons will appreciate the various possibilities to combine or integrate discrete elements into a single element. Such may include combining two or more circuits for form a single circuit, mounting two or more circuits onto a common chip or chassis to form an integrated element, executing discrete software components on a common processor core, etc. Conversely, skilled persons will recognize the possibility to separate a single element into two or more discrete elements, such as splitting a single circuit into two or more separate circuits, separating a chip or chassis into discrete elements originally provided thereon, separating a software component into two or more sections and executing each on a separate processor core, etc.

It is appreciated that implementations of methods detailed herein are demonstrative in nature, and are thus understood as capable of being implemented in a corresponding device. Likewise, it is appreciated that implementations of devices detailed herein are understood as capable of being implemented as a corresponding method. It is thus understood that a device corresponding to a method detailed herein may include one or more components configured to perform each aspect of the related method.

All acronyms defined in the above description additionally hold in all claims included herein.

What is claimed is:

1. A device, comprising:
a memory;
one or more processors, coupled to the memory, and configured to:
determine if a trigger frame, a block acknowledgment request (BAR) frame, or a block acknowledgment (BA) frame received by the device are secured;
initiate a message integrity code (MIC) calculation for a control integrity protocol (CIP); and
determine the additional authentication data (AAD) for control frame protection.

2. The device of claim 1, wherein the one or more processors are further configured to add a packet number (PN) after transmitting station address (TA) fields for BAR and BA and to add one or more user information fields that include a portion of one or more PN fields for a trigger frame.

3. The device of claim 2, wherein the one or more processors are further configured to add an MIC field after transmitting a PN field for a BAR and a BA, and to add the one or more user information fields after transmitting all user information fields that comprise a portion of the PN fields for the trigger frame.

4. The device of claim 2, wherein the one or more processors are configured to use an AAD that is generated based on a common portion identified for the trigger frame, the BAR, or the BA, and wherein the common portion comprises a frame control field, a duration field, an RA field, or a TA field.

5. The device of claim 4, wherein the one or more processors are further configured to leave the frame control field, the duration field, the RA field, and the TA field unmasked, such that the frame control field, the duration field, the RA field, and the TA field are protected.

6. The device of claim 1, wherein the one or more processors are further configured to compute an integrity value over a concatenation of AAD and fields after the TA field but before the MIC field for BAR or BA.

7. The device of claim 1, wherein the one or more processors are further configured to compute an integrity value over a concatenation of the AAD and fields that are after the TA field but before the User Info fields that comprises any portion of MIC field for the Trigger frame.

8. The device of claim 1, further comprising a transceiver configured to transmit and receive wireless signals.

9. A method, comprising:
determining whether a trigger frame, a block acknowledgment request (BAR) frame, or a block acknowledgment (BA) frame received by a device are secured;
initiating a message integrity code (MIC) calculation for a control integrity protocol (CIP); and
determining additional authentication data (AAD) for control frame protection.

10. The method of claim 9, further comprising adding a packet number (PN) after transmitting station address (TA) fields for BAR and BA and adding one or more user information fields that include a portion of one or more PN fields for a trigger frame.

11. The method of claim 10, further comprising adding an MIC field after transmitting a PN field for a BAR and a BA, and adding the one or more user information fields after transmitting all user information fields that comprise a portion of the PN fields for the trigger frame.

12. The method of claim 10, further comprising using an AAD that is generated based on a common portion identified for the trigger frame, the BAR, or the BA, and wherein the common portion comprises a frame control field, a duration field, an RA field, or a TA field.

13. The method of claim 12, further comprising leaving the frame control field, the duration field, the RA field, and the TA field unmasked, such that the frame control field, the duration field, the RA field, and the TA field are protected.

14. The method of claim 9, further comprising computing an integrity value over a concatenation of AAD and fields after the TA field but before the MIC field for BAR or BA.

15. The method of claim 9, further comprising computing an integrity value over a concatenation of the AAD and fields that are after the TA field but before the User Info fields that comprises any portion of MIC field for the Trigger frame.

16. A non-transitory computer readable medium, comprising instructions which, if executed by a processor, cause the processor to:
determine whether a trigger frame, a block acknowledgment request (BAR) frame, or a block acknowledgment (BA) frame received by a device are secured;
initiate a message integrity code (MIC) calculation for a control integrity protocol (CIP); and
determine additional authentication data (AAD) for control frame protection.

17. The non-transitory computer readable medium of claim 16, wherein the instructions are further configured to cause the processor to add a packet number (PN) after transmitting station address (TA) fields for BAR and BA and add one or more user information fields that include a portion of one or more PN fields for a trigger frame.

18. The non-transitory computer readable medium of claim 17, wherein the instructions are further configured to cause the processor to add an MIC field after transmitting a PN field for a BAR and a BA, and add the one or more user information fields after transmitting all user information fields that comprise a portion of the PN fields for the trigger frame.

19. The non-transitory computer readable medium of claim 17, wherein the instructions are further configured to cause the processor to use an AAD that is generated based on a common portion identified for the trigger frame, the BAR, or the BA, and wherein the common portion comprises a frame control field, a duration field, an RA field, or a TA field.

20. The non-transitory computer readable medium of claim 19, wherein the instructions are further configured to cause the processor to leave the frame control field, the duration field, the RA field, and the TA field unmasked, such that the frame control field, the duration field, the RA field, and the TA field are protected.
